(19) United States
(12) Patent Application Publication
(10) Pub. No.: US 2026/0203214 A1
(43) Pub. Date: Jul. 16, 2026

(54) Monotonic State Machine for Tracking Concurrent Operations

(71) Applicant: Oracle International Corporation, Redwood Shores, CA (US)

(72) Inventors: Erik Österlund, Vasterhaninge (SE); Axel Boldt-Christmas, Stockholm (SE); Stefan Mats Rikard Karlsson, Nacka (SE)

(73) Assignee: Oracle International Corporation, Redwood Shores, CA (US)

(21) Appl. No.: 19/021,853

(22) Filed: Jan. 15, 2025

(51) Int. Cl. G06F 12/02

(52) U.S. Cl. CPC G06F 12/0269

(57) ABSTRACT

Techniques are disclosed for managing the processing of pointers during a concurrent phase of operations using a monotonic state machine. The monotonic state machine defines multiple distinct state designations. During the phase of concurrent operations, the state of any given pointer may be described by a state designation defined by the monotonic state machine. The state designations defined by the state machine have stacking requirements. For example, a third state designation corresponding to a greater level of accessibility necessarily implies a second state designation corresponding to a lesser level of accessibility. The system models changes to a pointer's state during the phase of concurrent operations as monotonic transitions between state designations. If a pointer is transitioned from a former state designation to a latter state designation during the phase of concurrent operations, the pointer is not reverted backwards to the former state designation during the phase of concurrent operations.

### TECHNICAL FIELD

The present disclosure relates to a monotonic state machine that is used for tracking state information during phases of concurrent operations.

### BACKGROUND

With respect to a computing architecture, the term “concurrency” refers to the ability of a computing system to perform multiple operations simultaneously and/or the ability of the computing system to perform multiple operations in overlapping time periods. Concurrency can improve the efficiency and performance of a computing system. However, concurrency can give rise to an issue that results from one operation interfering with another operation that is being performed at the same time (referred to as a “concurrency issue”). Examples of concurrency issues include termination indeterminism, race conditions, deadlock, livelock, starvation, and others.

A “state machine” is a computational framework that can be used to model the behavior of a computing system. An example state machine defines multiple distinct state designations that can be used to describe the state of a computing entity. The example state machine models the behavior of a computing system that alters the computing entity's state as transitions between the state designations.

As used herein, the term “monotonic” refers to moving in one direction. For instance, a value that increases but does not decrease is an example of a monotonic value, and another value that decreases but does not increase is another example of a monotonic value.

In the field of computer science, the term “garbage collection” is used to refer to memory management. For example, a “garbage collection process” may refer to a process for reclaiming memory allocated to a program instance. Once memory allocated to a program instance has been reclaimed by a garbage collection process, that reclaimed memory may be reused by that program instance or another program instance.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced according to an embodiment;

FIG. 2 is a block diagram illustrating one embodiment of a computer system suitable for implementing methods and features described herein;

FIG. 3 illustrates an example virtual machine memory layout in block diagram form according to an embodiment;

FIG. 4 illustrates an example frame in block diagram form according to an embodiment;

FIG. 5 illustrates an example memory area in which techniques described herein may be practiced according to an embodiment;

FIG. 6 illustrates a garbage collection system according to an embodiment;

FIG. 7 illustrates a garbage collection cycle in block diagram form according to an embodiment;

FIG. 8 illustrates a monotonic state machine in block diagram form according to an embodiment;

FIG. 9 illustrates an example colored pointer architecture in block diagram form according to an embodiment;

FIG. 10 illustrates an example set of operations for monotonic processing pointers according to an embodiment;

FIG. 11 illustrates an example set of operations performed pursuant to a load barrier according to an example embodiment;

FIG. 12 illustrates an example set of operations performed pursuant to a store barrier according to an example embodiment;

FIG. 13 illustrates an example set of operations for coloring a pointer according to an example embodiment; and

FIG. 14 illustrates a computer system in block diagram form according to an embodiment.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, & INITIALIZING
   2.4 EXAMPLE MEMORY AREA
3. GARBAGE COLLECTION SYSTEM
4. GARBAGE COLLECTION CYCLE
5. MONOTONIC STATE MACHINE
6. COLORED POINTER ARCHITECTURE
7. MONOTONIC PROCESSING OF POINTERS
8. EXAMPLE EMBODIMENT
   8.1 EXAMPLE LOAD BARRIER
   8.2 EXAMPLE STORE BARRIER
   8.3 EXAMPLE POINTER COLORING
9. HARDWARE OVERVIEW
10. MISCELLANEOUS; EXTENSIONS

### 1. General Overview

One or more embodiments manage a phase of concurrent operations during a garbage collection cycle by modeling the processing of pointers during the phase of concurrent operations according to a monotonic state machine that defines a second state designation corresponding to a runtime object referred to by a pointer having a lesser level of accessibility and a third state designation corresponding to a runtime object referred to by a pointer possessing a greater level of accessibility that necessarily implies the lesser level of accessibility. Furthermore, the monotonic state machine defines a first state designation corresponding to a pointer not needing to be remapped, and the monotonic state machine defines a fourth state designation corresponding to a pointer having been added to a remembered set. The remembered set is a data structure that is used to track references that potentially cross intergenerational boundaries of the memory area being subjected to the garbage collection cycle. Note that the fourth state designation also implies that the pointer has been remapped from one runtime object to another runtime object during a phase of concurrent operations. If the garbage collection process is non-generational, the fourth state designation's primary implication is that the pointer has been remapped from one runtime object to another runtime object during a phase of concurrent operations. As used herein, the term “phase of concurrent operations” refers to a period of time in which multiple operations may be performed concurrently in the same computing environment. For the purpose of brevity, a phase of concurrent operations may be referred to herein in short as a “concurrent phase.”

While processing a pointer that refers to a dataset residing at a location in memory during a concurrent phase, one or more embodiments model changes to the pointer's state as monotonic transitions between state designations defined by a monotonic state machine. The monotonic state machine defines (a) a first state designation corresponding to the pointer storing the correct address of the location in memory, (b) a second state designation corresponding to the dataset possessing a lesser level of accessibility while residing at that location in memory, (c) a third state designation corresponding to the dataset possessing a greater level of accessibility while residing at that location in memory, and (d) a fourth state designation corresponding to the pointer having been added to a remembered set and/or remapped from another dataset to the dataset during the concurrent phase. The state designations are defined such that a latter state designation necessarily implies a former state designation. For example, if the dataset possesses the greater level of accessibility while residing at that location, the dataset necessarily possesses the lesser level of accessibility while residing at that location. Therefore, if the pointer qualifies for the third state designation, the pointer necessarily qualifies for the second state designation. Transitions between the state designations are “monotonic” in the sense that the pointer cannot revert from a latter state designation to a former state designation during the concurrent phase. For example, if the pointer is transitioned from the second state designation to the third state designation during the concurrent phase, the pointer cannot be transitioned backwards to the second state designation during that concurrent phase.

While processing a pointer that refers to a runtime object residing in runtime memory allocated to a program instance that is concurrently executing, one or more embodiments track a state designation of the pointer by embedding metadata into bits within the pointer that are not being used to store an address of a location in memory that is associated with the runtime object. As used herein, embedding metadata into bits within a pointer that are not needed for storing an address is referred to as “coloring the pointer.” The pointer is colored with specific values, referred to as “good colors.” The system assigns a state designation to the pointer by storing one or more good colors within the pointer. Note that the system may reset the monotonic state machine by determining new good colors. When the system determines new good colors, the previous good colors become bad colors, and any state designations assigned to the pointer are lost. While processing the pointer during a concurrent phase, the system stores (a) a first good color within the pointer if the pointer does not need to be remapped to the runtime object, (b) a second good color within the pointer if the runtime object is reachable, (c) a third good color within the pointer if the runtime object is strongly reachable, and (d) a fourth good color within the pointer if the program instance has remapped the pointer from another runtime object to the runtime object since good colors were last updated. Recall that a monotonic state machine is characterized by monotonic transitions between state designations. Therefore, pointer coloring is strictly monotonic as well for as long as the good colors remain constant. If the system stores a good color to the pointer, the system does not remove that color from the pointer unless that color becomes a bad color.

One or more embodiments described in this Specification and/or recited in the claims may not be included in this General Overview section.

### 2. Architectural Overview

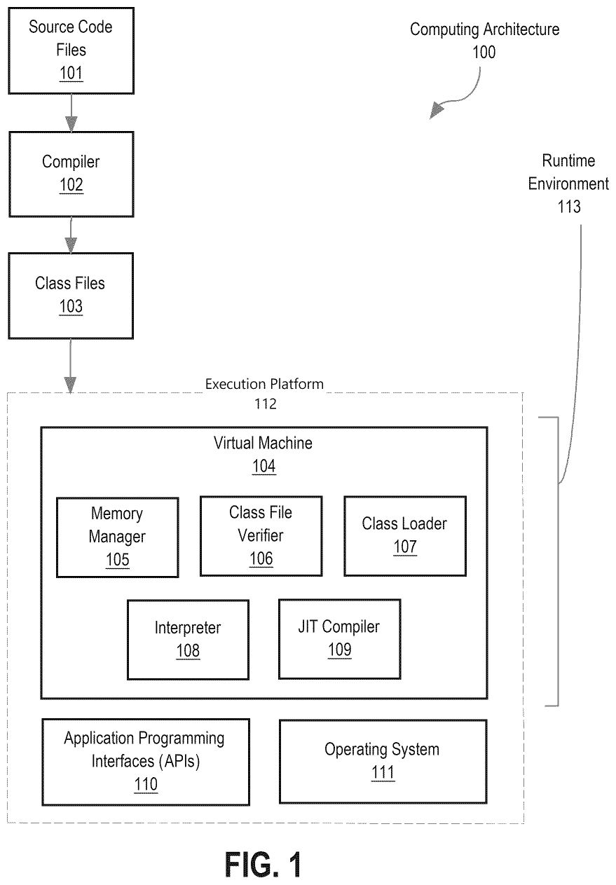

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that contain code that has been written in a particular programming language, such as Java, C, C++, C #, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may contain one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

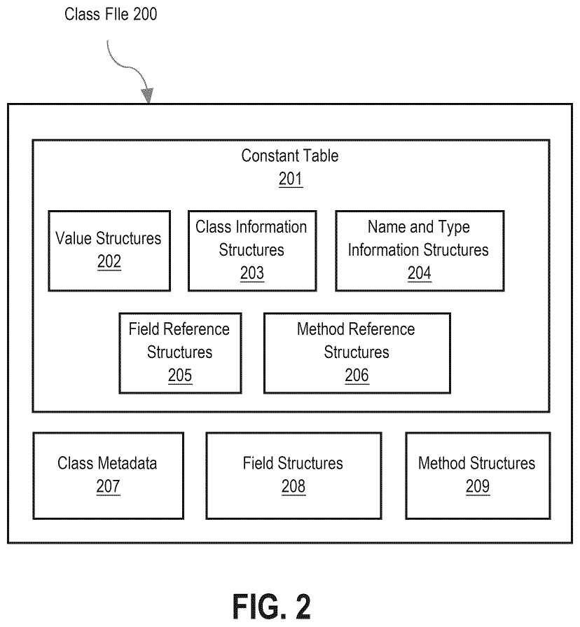

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”= byte, “C”=char, “D”=double, “F”=float, “I”=int, “J”=long int, etc.). When a field holds an object, the descriptor is a string that identifies the class name of the object (e.g. “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t)” matches the descriptor “(I D L Thread) L Object”.

In an embodiment, the virtual machine instructions held in the method structures 209 include operations which reference entries of the constant table 201. Using Java as an example, consider the following class:
class A
{
   int add12and13( ) {
      return B. addTwo(12, 13);
   }
}

In the above example, the Java method add12and13 is defined in class A, takes no parameters, and returns an integer. The body of method add12and13 calls static method addTwo of class B which takes the constant integer values 12 and 13 as parameters, and returns the result. Thus, in the constant table 201, the compiler 102 includes, among other entries, a method reference structure that corresponds to the call to the method B. addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

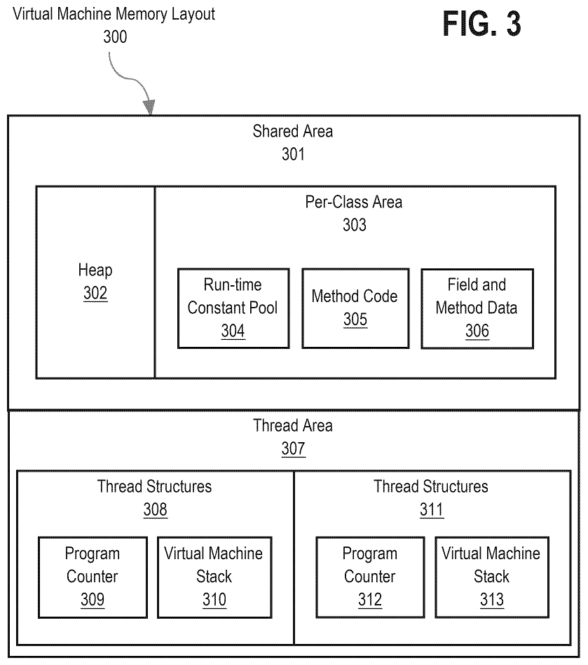

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area from which memory for class instances and arrays is allocated. In an embodiment, the per class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

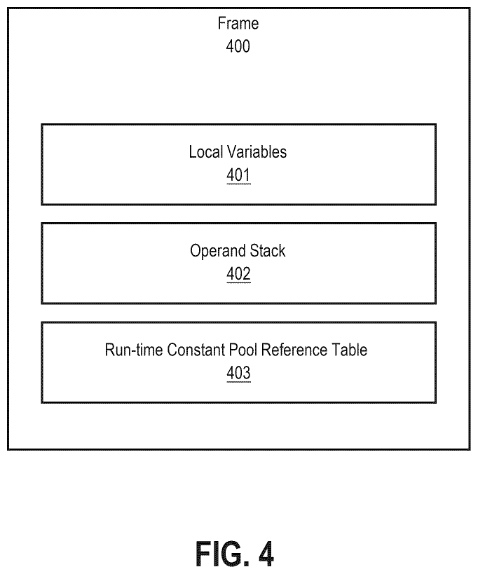

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 contains a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, & Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 2.4 Example Memory Area

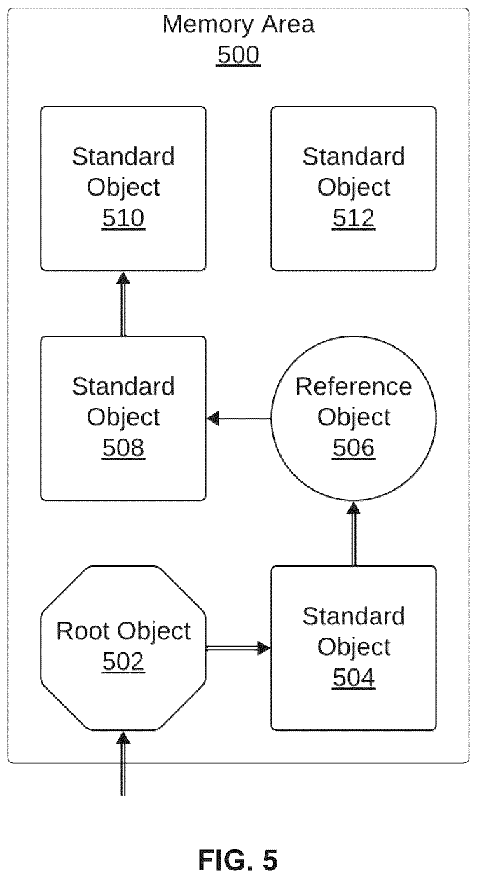

FIG. 5 illustrates an example memory area 500 in which techniques described herein may be practiced in accordance with one or more embodiments. A detailed example is described in this Section 2.4 for purpose of clarity and understanding. Components and/or operations described below should be understood as one specific example that may not be applicable to certain embodiments. Accordingly, components and/or operations described below should not be construed as limiting the scope of any of the claims.

In an embodiment, a memory area 500 is allocated for storing runtime objects associated with one or more program instances. The runtime objects residing in memory area 500 are instantiations of reference types (e.g., classes). One runtime object residing in memory area 500 may refer to another runtime object residing in memory area 500 by possessing an object field that holds a reference to the other runtime object. Runtime objects are represented in FIG. 5 as enclosed planar shapes (e.g., a circle, a square, a hexagon, etc.). References to runtime objects residing in memory area 500 are represented in FIG. 5 as arrows. A conceptualization of runtime objects that are linked together by references between the runtime objects (e.g., as depicted in FIG. 5) may be referred to herein as an “object graph.” Note that (a) the example illustrated by FIG. 5 is limited to depicting references and runtime objects residing in memory area 500 that are exposed at a program level and (b) FIG. 5 does not depict any references or runtime objects residing in memory area 500 that are not exposed at a program level. To provide clear examples, the remainder of the discussion in this Section 2.4 with reference to FIG. 5 assumes that memory area 500 includes no runtime objects or references that are exposed at a program level other than those runtime objects and references that are illustrated in FIG. 5.

In an embodiment, a memory area 500 includes root object(s). As used herein, the term “root object” refers to a runtime object that is referred to by a root, and the term “root” identifies a reference to a runtime object that may serve as an entry point to a memory area that the runtime object resides in. In the example illustrated by FIG. 5, memory area 500 includes a single root object 502. However, it should be understood that a memory area 500 can (and often does) include multiple root objects. Note that the root that refers to runtime object 502 does not originate from any other runtime object within memory area 500. Instead, the root originates from somewhere outside of memory area 500. For example, the root that is pointing to root object 502 may be held by a stack variable, a global variable, a static variable, a local variable, or another data structure outside of memory area 500.

In an embodiment, a memory area 500 includes standard object(s). As used herein, the term “standard object” refers to a runtime object that is neither a root object nor a reference object. In the example illustrated by FIG. 5, memory area 500 includes standard object 504, standard object 508, standard object 510, and standard object 512.

In an embodiment, a memory area 500 includes reference object(s). A reference object is a special type of runtime object that is used to indirectly refer to another runtime object. A runtime object that a reference object is used to refer to is identified as the reference object's “referent.” Examples of reference objects include soft reference objects, weak reference objects, final reference objects, phantom reference objects, and others. Note that, unlike other example reference objects, a final reference object is not exposed at the program level. In the example illustrated by FIG. 5, memory area 500 includes reference object 506, and standard object 508 is the referent of reference object 506. Standard object 504 indirectly refers to standard object 508 through reference object 506.

It should be noted that reference objects are often referred to colloquially as “references” rather than “objects.” For example, a soft reference object is often referred to as a “soft reference,” a weak reference object is often referred to as a “weak reference,” a final reference object is often referred to as a “final reference,” and a phantom reference object is often referred to as a “phantom reference.” However, for the purposes of clarity and understanding, reference objects are not intentionally referred to herein as references rather than objects. Instead, as used herein, the term “soft reference” identifies a reference that links a soft reference object to the soft reference object's referent, the term “weak reference” identifies a reference that links a weak reference object to the weak reference object's referent, the term “final reference” identifies a reference that links a final reference object to the final reference object's referent, and the term “phantom reference” identifies a reference that links a phantom reference object to the phantom reference object's referent. For instance, in the example context of FIG. 5, if reference object 506 is a soft reference object, the reference that links reference object 506 to standard object 508 (i.e., the referent of reference object 506) may be referred to as a “soft reference.”

In an embodiment, a memory area 500 includes dereferenceable reference object(s), and/or the memory area 500 includes non-dereferenceable reference object(s). As used herein, a “dereferenceable reference object” refers to a reference object that (a) is exposed at a program level and (b) can be leveraged by a program instance to access the reference object's referent. A reference object typically will declare a get( ) method, and a program instance may attempt to dereference that reference object by calling the get( ) method. In the example illustrated by FIG. 5, reference object 506 is a dereferenceable reference object, or reference object 506 is a non-dereferenceable reference object. If reference object 506 is dereferenceable, then standard object 508 and standard object 510 are accessible to a program instance; however, if reference object 506 is non-dereferenceable, then standard object 508 and standard object 510 are not accessible to a program instance. Reference object 506 is dereferenceable if (a) reference object 506 is a weak reference object or a soft reference object, and (b) reference object 506 has not been cleared. Note that, in this scenario, calling the get( ) method will return the referent of reference object 506 (i.e., standard object 508). In contrast, if reference object 506 has been cleared, reference object 506 is non-dereferenceable, and calling the get( ) method of reference object 506 will return null. Alternatively, if reference object 506 is a phantom refence object, reference object 506 is non-dereferenceable starting from the moment reference object 506 is instantiated. Phantom reference objects also possess a get( ) method; however, a get( ) method offered by a phantom reference object is generally configured to return null starting from the moment the phantom reference object is instantiated. Thus, phantom reference objects are generally non-dereferenceable. However, note that while a get( ) method of a phantom reference object is often configured to return null, a get( ) method of a phantom reference object can be configured to return the phantom reference object's referent. Accordingly, in some cases, a phantom reference object may be dereferenceable. Final reference objects are not exposed at a program level; therefore, final reference objects are also non-dereferenceable. Note that above discussion in this paragraph refers generally to the behavior of standard soft reference objects, standard weak reference objects, standard final reference objects, and standard phantom reference objects. The behavior of a modified reference object (e.g., a modified soft reference object) or a custom reference object may differ.

In an embodiment, a memory area 500 includes non-strong reference(s), and/or memory area 500 includes strong reference(s). A “non-strong reference” is the special type of reference that is created by a reference object. In particular, a non-strong reference is the reference that links a reference object to the reference object's referent. The non-strong reference that is created by a reference object is held by an object field of the reference object known as the “referent field.” References other than non-strong references are identified as “strong references.” Strong references are “strong” in the sense that a strong reference to a runtime object may prevent that runtime object from being collected by a garbage collection process in some circumstances. Note that strong references are presented in FIG. 5 as double-lined arrows (e.g., ⇒), and non-strong references are represented in FIG. 5 as single-lined arrows. As used herein, a runtime object that holds a strong reference to another runtime object is said to “strongly refer” to the other runtime object, a soft reference object is said to “softly refer” to the soft reference object's referent, and a weak reference object is said to “weakly refer” to the weak reference object's referent.

In an embodiment, a memory area 500 includes reachable runtime object(s), and/or memory area 500 includes unreachable runtime object(s). Examples of a reachable runtime object include a strongly reachable object, a softly reachable object, a weakly reachable object, a finalizably reachable object, a phantom reachable object, and others. Note that the term “reachable” does not necessarily imply that a runtime object is accessible to a program instance. In the example illustrated by FIG. 5, root object 502, standard object 504, reference object 506, and standard object 508 are reachable. If reference object 506 is a phantom reference object, standard object 510 is unreachable; otherwise, standard object 510 is reachable in some manner. Standard object 512 is inaccessible to a program instance; however, standard object 512 is not necessarily unreachable. For instance, standard object 512 might be finalizably reachable. Recall that (a) FIG. 5 is limited to depicting references and runtime objects that are exposed at a program level, and (b) final references are not exposed at a program level.

In an embodiment, a memory area 500 includes strongly reachable runtime object(s). As used herein, a runtime object is considered “strongly reachable” if that runtime object can be accessed without having to traverse any reference object. In effect, root objects are strongly reachable, and a runtime object other than a root object (e.g., a standard object or a reference object) is strongly reachable if the runtime object is accessible through a chain of strong reference(s) that link the runtime object to a root object. In the example illustrated by FIG. 5, root object 502, standard object 504, and reference object 506 are strongly reachable. As used herein, the term “strong object graph” refers a network of strongly reachable runtime objects. For example, the term “strong object graph” with respect to FIG. 5 collectively refers to root object 502, standard object 504, reference object 506, and the interleaving strong references between those runtime objects.

In an embodiment, a memory area 500 includes softly reachable runtime object(s). As used herein, a runtime object is “softly reachable” if the runtime object (a) is not strongly reachable and (b) is accessible by traversing at least one reference object without having to traverse any weak reference object, final reference object, or phantom reference object. In effect, a runtime object is softly reachable if (a) the runtime object is reachable through a chain of reference(s) that links the runtime object to a root object, (b) the chain of reference(s) includes at least one soft reference, (c) the chain of reference(s) does not include a weak reference, and (d) the runtime object is not strongly reachable. In the example illustrated by FIG. 5, if reference object 506 is a soft reference object, then standard object 508 and standard object 510 are softly reachable. Note that, in this scenario, standard object 510 is softly reachable despite the fact that (a) standard object 510 is not a referent of a soft reference object, and (b) standard object 508 strongly refers to standard object 510.

In an embodiment, a memory area 500 includes weakly reachable runtime object(s). As used herein, a runtime object is referred to as “weakly reachable” if (a) the runtime object is accessible through a weak reference, and (b) the runtime object is neither strongly reachable nor softly reachable. In effect, a runtime object is weakly reachable if (a) the runtime object is accessible through a chain of reference(s) that links the runtime object to a root object, (b) the chain of reference(s) includes at least one weak reference, and (c) the runtime object is neither strongly reachable nor softly reachable. In the example depicted by FIG. 5, if reference object 506 is a weak reference object, then standard object 508 and standard object 510 are weakly reachable.

In an embodiment, a memory area 500 includes finalizably reachable runtime object(s). As used herein, a runtime object is referred to as “finalizably reachable” if the runtime object (a) is neither strongly reachable, softly reachable, nor weakly reachable and (b) is accessible through a chain of reference(s) that includes a final reference. Recall that final reference objects are non-dereferenceable. Therefore, the term “finalizably reachable” is somewhat of a misnomer in the sense that a finalizably “reachable” object is generally inaccessible to a program instance. However, note that a finalizably reachable object is accessible to a garbage collection process. For example, in the context of a multi-thread computing environment, a finalizably reachable runtime object is accessible to a thread that is responsible for executing finalizer methods (referred to as a “finalizer thread”). In an example implementation of memory area 500, a final reference object is instantiated when a finalizable object is instantiated, and the finalizable object is set as the referent of the final reference object. As used herein, a “finalizable object” is a runtime object that possess a defined finalizer method. An instance of a subclass that overrides a finalizer method of a super class (e.g., the finalizer method of the Java Object class) is one example of a finalizable object. A finalizable object may become finalizably reachable through a corresponding final reference object after the finalizable object becomes unreachable through other references. In the example illustrated by FIG. 5, standard object 512 may be finalizably reachable or may become finalizably reachable if standard object 512 is a finalizable object. However, it should also be noted that (a) a finalizably reachable object is not necessarily a finalizable object, and (b) a finalizably reachable object is not necessarily a referent of a final reference object. As an example, consider a referent of a final reference object (i.e., a finalizable object), and assume that the referent is finalizably reachable. In this example, if (a) the referent refers to another runtime object and (b) the other runtime object is not reachable through any other reference, the other runtime object is also finalizably reachable.

In an embodiment, a memory area 500 includes phantom reachable runtime object(s). As used herein, a runtime object is referred to as “phantom reachable” if (a) the runtime object is neither strongly reachable, softly reachable, weakly reachable, nor finalizably reachable, (b) any finalizer associated with the runtime object has already been called, and (c) the runtime object is reachable through one or more phantom references. In general, a phantom reachable object is a runtime object that has been finalized but not yet reclaimed by a garbage collection process. Recall that a phantom reference object is non-dereferenceable. Therefore, the term “phantom reachable” is also somewhat of a misnomer because a phantom “reachable” object is generally not accessible to a program instance. A phantom reachable object is generally not accessible to a program instance because a get method offered by a phantom reference object is typically configured to return null. In the example illustrated by FIG. 5, if reference object 506 is a phantom reference object, and if neither standard object 508 nor standard object 510 are finalizably reachable, then standard object 508 and standard object 510 are phantom reachable.

As used herein, the term “reachability status” refers generally to whether a runtime object is considered strongly reachable, softly reachable, weakly reachable, finalizably reachable, phantom reachable, or unreachable. Note that a runtime object's reachability status corresponds to the strongest form of reachability that the runtime object possesses. As an example, assume that a runtime object is strongly reachable through one chain of references, and further assume that the runtime object is softly reachable through another chain of references. In this example, the runtime object's is considered strongly reachable rather than softly reachable. The relative strength of reachability statuses, from strongest to weakest, is (a) strongly reachable, (b) softly reachable, (c) weakly reachable, (d) finalizably reachable, and (e) phantom reachable. Note that the reference objects described in this Section 2.4 do not represent an exhaustive list of reference objects. For instance, another example of a reference object is a native weak reference object. Reachability through a native weak reference object is considered of equal strength to phantom reachability. However, unlike a phantom reference object, a native weak reference object is generally dereferenceable.

In an embodiment, the reachability status of any given runtime object residing in a memory area 500 may change. For instance, the reachability status of a runtime object may be downgraded, and/or the reachability status of a runtime object may be upgraded. As used herein, the term “resurrection” refers to an upgrade to a runtime object's reachability status. For example, a runtime object that is merely softly reachable or weakly reachable is said to be “resurrected” if that runtime object subsequently becomes strongly reachable. Softly reachable objects and weakly reachable objects are examples of runtime objects that can be resurrected. Note the resurrection of one runtime object may trigger the resurrection of another runtime object. As an example, assume that reference object 506 is a soft reference object or a weak reference object. Recall that a reference object that is a soft reference object or a weak reference object will typically declare a get( ) method, and calling the get( ) method may return the reference object's referent if the reference object has not been cleared. Note that an operation that involves a successful invocation of a get( ) method of a reference object will typically create a new strong reference to the reference object's referent, and the new strong reference generally will render the referent strongly reachable, at least temporarily. Thus, in this example, if a get( ) method of reference object 506 is successfully invoked (i.e., the get( ) method does not return null), standard object 508 and standard object 510 may both become strongly reachable (and therefore ineligible for collection by a garbage collection cycle). A finalizably reachable runtime object is another example of a runtime object that can be resurrected. As an example, assume that standard object 512 is a finalizably reachable object. In this example, executing the finalizer method targeting standard object 512 may temporarily render standard object 512 strongly reachable by creating a temporary strong reference to standard object 512 that originates from outside of memory area 500. However, note that if standard object 512 subsequently reverts back to being not reachable in this example (as might be expected in the example depicted by FIG. 5), the corresponding finalizer method will not be called again to resurrect standard object 512 a second time.

### 3. Garbage Collection System

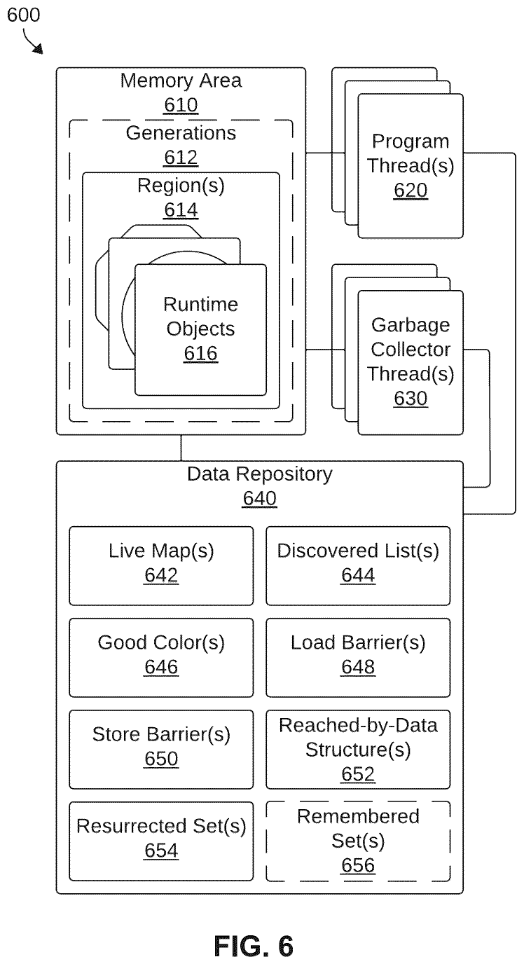

FIG. 6 illustrates a system 600 for performing techniques described herein in accordance with one or more embodiments. As illustrated in FIG. 6, system 600 includes memory area 610, program thread(s) 620, garbage collector thread(s) 630, and data repository 640. In one or more embodiments, system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

In an embodiment, system 600 refers to hardware and/or software configured to perform a garbage collection process. As used herein, the term “collection operation” may refer to any operation that is performed in furtherance of a garbage collection process, and the term “program operation” may refer to any operation other than a collection operation. During the garbage collection process, the system 600 is configured to complete garbage collection cycle(s). A garbage collection cycle that is performed by system 600 may include multiple phases of collection operations. An example garbage collection cycle includes a marking phase, a reference processing phase, a selection phase, a relocation phase, and/or other phases. As used herein, the term “marking operation” refers to a collection operation that occurs during a marking phase, the term “reference processing operation” refers to a collection operation that occurs during a reference processing phase, the term “selection operation” refers to a collection operation that occurs during a selection phase, and the term “relocation operation” refers to a collection operation that occurs during a relocation phase. Note that any given phase of a garbage collection cycle may be a concurrent phase. A garbage collection cycle that includes at least one concurrent phase is referred to herein as a “concurrent garbage collection cycle.” Additional embodiments and/or examples related to a garbage collection cycle are described below in Section 4 titled “Garbage Collection Cycle.”

Additional embodiments and/or examples relating to performing a garbage collection process are described within R01333NP and R01333N3. R01333NP and R01333N3 are incorporated by reference in entirety as if set forth herein.

In an embodiment, system 600 refers to hardware and/or software configured to process pointers during concurrent phases in accordance with a monotonic state machine. As used herein, the term “pointer” refers to a grouping of bits that is configured to store the address of a location in memory. Note that a reference to a runtime object (e.g., a strong reference or a non-strong reference) may be implemented in low-level memory, at least in part, using a pointer. The monotonic state machine defines multiple distinct state designations that can be used to describe a pointer's state during a concurrent phase, and the behavior of the system 600 while manipulating a pointer during the concurrent phase can be modeled as transitions between the state designations. Additional embodiments and/or examples relating to a monotonic state machine that is used to model the behavior of system 600 is described below in Section 5, titled “Monotonic State Machine.”

In an embodiment, memory area 610 is any type of storage unit and/or device (e.g., a file system, database, collection of tables, or any other storage mechanism) for storing data. Furthermore, memory area 610 may include multiple different storage units and/or devices. The multiple different storage units and/or devices may or may not be of the same type or located at the same physical site. Memory area 610 is implemented or executed on the same computing system as other components of system 600, and/or memory area 610 is implemented or executed on a computing system that is separate from other components of system 600. Memory area 610 is communicatively coupled to other component(s) of system 600 via physical link(s), and/or data repository 640 is communicatively coupled to other component(s) of system 600 via wireless link(s). Memory area 610 may include volatile memory, and/or memory area 610 may include non-volatile memory.

In an embodiment, memory area 610 is allocated for runtime memory of a single program instance, or memory area 610 is allocated for runtime memory of multiple program instances. The program instance(s) may be implemented, in whole or in part, using one or more class-based, object-oriented programming languages. Examples of class-based, object-oriented programming languages include Java, C++, C #, Python, Ruby, and others. In the example context of virtual machine memory layout 300 as illustrated in FIG. 3, memory area 610 may reside in heap 302, and runtime objects 616 may be manifested as instances of reference types (e.g., classes) that are instantiated during the runtime of at least one program instance. This implementation of memory area 610 in the context of class-based, object-oriented program language(s) is described herein for illustrative purposes and is not intended to define any limits to the disclosure. It should be understood that the techniques described herein are equally applicable to other contexts and computing environments.

In an embodiment, memory area 610 is organized into multiple generations 612. A generation 612 is a section of memory area 610 that is used to organize information stored to memory area 610. An example generation 612 is a logical subdivision of memory area 610. Note that a logical subdivision of memory area 610 need not be associated with any spatial boundaries within memory area 610. A runtime object 616 may be organized into a generation 612 based on temporal attributes, reachability status, type, and/or other characteristics. Example temporal attributes of a runtime object 616 include time elapsed since the runtime object 616 was created, time elapsed since the runtime object 616 was last accessed, time elapsed in relation to the creation or use of another runtime object 616, and others. In an example, memory area 610 includes a young generation, and memory area 610 includes an old generation. Note that the boundaries of a generation 612 are not necessarily demarcated based on any temporal attributes of runtime objects 616.

In an embodiment, information stored to memory area 610 is organized into region(s) 614. A region 614 is a basic unit of memory allocation within memory area 610 that may be independently managed during a garbage collection cycle. For example, during a garbage collection cycle, an individual region 614 may be selected as a candidate region for relocation operations.

In an embodiment, runtime objects 616 includes root object(s), standard object(s), reference object(s), and/or other types of runtime objects 616. If a runtime object 616 is a reference object, the runtime object 616 is a soft reference object, a weak reference object, a final reference object, a phantom reference object, or another type of reference object. A runtime object 616 may refer to another runtime object 616 residing in memory area 610. If a runtime object 616 refers to another runtime object 616, the runtime object 616 refers to a single other runtime object 616, or the runtime object 616 refers to multiple other runtime objects 616. A runtime object 616 residing in memory area 610 is exposed at a program level, or the runtime object 616 is not exposed at the program level (e.g., a final reference object).

In an embodiment, a runtime object 616 residing in memory area 610 is eligible for collection by a garbage collection process, or the runtime object 616 is ineligible for collection by a garbage collection process. As used herein, the term “disposable” refers to eligibility for collection by a garbage collection process, and the term “non-disposable” refers to ineligibility for collection by a garbage collection process. Note that a runtime object 616 that is deemed to be disposable during a garbage collection cycle is not necessarily collected by that garbage collection cycle. In an example, a garbage collection cycle targeting memory area 610 reclaims the memory that is occupied by the disposable runtime objects 616 residing in a subset of the regions 614 within memory area 610. Thus, disposable runtime objects 616 not residing in the subset of the regions 614 are not collected during the garbage collection cycle of this example.

In an embodiment, a runtime object 616 is a strongly reachable object, a softly reachable object, a weakly reachable object, a finalizably reachable object, a phantom reachable object, or an unreachable object. A runtime object's 616 eligibility for collection during a garbage collection cycle may depend upon the runtime object's 616 reachability status and/or other factors. For example, strongly reachable objects are typically considered non-disposable, whereas unreachable objects are typically considered disposable. A runtime object that is reachable but less than strongly reachable may be considered disposable or non-disposable depending on the circumstances. Note that in some cases, a runtime object 616 may be treated as strongly reachable (and therefore non-disposable) regardless of whatever that runtime object's 616 actual reachability status may be. It should also be noted that a runtime object's 616 eligibility for collection by a garbage collection cycle may depend on factors other than the runtime object's 616 reachability status.

In an embodiment, a runtime object 616 is a live object, or the runtime object 616 is a dead object. As used herein, the term “live object” refers to a runtime object that is marked as live in at least one record of state information, and a “dead object” refers to a runtime object that has not been marked as live. A runtime object 616 marked as live during a garbage collection cycle is generally not collected by that garbage collection cycle. On the other hand, a runtime object 616 that is not marked as live during a garbage collection cycle (i.e., a dead object) may or may not be collected by that garbage collection cycle. Note that a runtime object 616 may be a live object during one garbage collection cycle, and the runtime object 616 may be a dead object during a subsequent garbage collection cycle.

As illustrated in FIG. 6, system 600 may be implemented, at least in part, using a multi-thread computing system. A multi-thread computing system is one example of a computing system capable of performing concurrent operations. The implementation of system 600 in the context of a multi-thread computing system is described herein for illustrative purposes and is not intended to define any limits to this disclosure. It should be understood that techniques herein are equally applicable to other computer architectures. For instance, the techniques described herein may be applicable to any computer architecture that is capable of concurrency.

In an embodiment, program thread(s) 620 are execution environment(s) for machine-level instructions. A program thread 620 is generally allocated for performing the machine-level code of a program instance. In other words, a program thread 620 generally performs program operations. Note that when a program thread 620 is performing the machine-level code of a program instance (i.e., program operations), runtime objects 616 that are not exposed at a program level (e.g., final reference objects) are inaccessible to that program thread 620 because the machine-level code of the program instance is unable to describe resources that are not exposed at a program level. While a program thread 620 primarily performs program operations, the program thread 620 may be further configured to execute machine-level code of a garbage collection process (i.e., collection operations). In particular, a program thread 620 can be made to perform collection operations by imposing a barrier (e.g., a load barrier 648 or a store barrier 650) on that program thread 620. As used herein, the term “barrier” refers to an additional set of machine-level instructions inserted into the machine-level code that is performed by an execution environment. In the example context of execution platform 112 as illustrated in FIG. 1, a barrier is imposed on a program thread 620 when JIT compiler 109 inserts the machine-level instructions defined by the barrier into the machine-level code of the program instance that is being performed by that program thread 620.

In an embodiment, garbage collector thread(s) 630 are execution environment(s) for machine-level instructions. A garbage collector thread 630 is configured for performing machine-level code of a garbage collection process. Accordingly, a garbage collector thread 630 primarily performs collection operations. Note that a garbage collector thread 630, while performing a collection operation, may access information that is not exposed at a program level. For example, a garbage collector thread 630 may access final reference objects, and a garbage collector thread 630 may traverse final references to access finalizably reachable objects.

In an embodiment, garbage collector thread(s) 630 are configured to perform collection operations while program thread(s) 620 are concurrently performing program operations. For instance, while a program thread 620 is performing program operations, a garbage collector thread 630 may be performing marking operations, reference processing operations, selection operations, relocation operations, and/or other collection operations. Recall that a program thread 620 may perform collection operations pursuant to a barrier. Note that a program thread 620 may perform a collection operation pursuant to a barrier while another program thread 620 is concurrently performing a program operation. It should also be noted that the term “garbage collector” is used herein to refer broadly to any execution environment that is performing a collection operation. Thus, in example context of system 600 as illustrated in FIG. 6, the term “garbage collector” may be used herein to identify a program thread 620 performing a collection operation, and the term “garbage collector” may be used herein to identify a garbage collector thread 630 performing a collection operation.

In an embodiment, program thread(s) 620 and garbage collector thread(s) 630 are configured to generate and/or update records of state information while performing collection operations. Stated differently, a garbage collector is configured to generate records of state information. Example records of state information include a live map 642, a discovered list 644, a colored pointer, a reached-by-data structure 652, a resurrected set 654, a remembered set 656, and others. As used herein, the term “marking” refers generally to recording state information. For example, during a marking phase a garbage collector “marks through” runtime objects 616 residing in memory area 610 to generate records of state information. However, note that a garbage collector may record state information (e.g., by marking through runtime objects 616) throughout a garbage collection cycle (e.g., during a reference processing phase, a selection phase, a relocation phase, etc.). It is also worth noting here that the term “marking operation” does not necessarily refer to marking through a runtime object 616. Recall that the term “marking operation” refers to any collection operation (marking or otherwise) that occurs during a marking phase. A garbage collector may perform operations during a marking phase that do not entail writing to a record of state information. Thus, the term “marking operation” does not necessarily identify an operation that entails recording state information.

In an embodiment, a data repository 640 is any type of storage unit and/or device (e.g., a file system, database, collection of tables, or any other storage mechanism) for storing data. Furthermore, a data repository 640 may include multiple different storage units and/or devices. The multiple different storage units and/or devices may or may not be of the same type or located at the same physical site. Furthermore, a data repository 640 may be implemented or executed on the same computing system as other components of system 600. Additionally, or alternatively, a data repository 640 may be implemented or executed on a computing system separate from other components of system 600. The data repository 640 may be communicatively coupled to other components of system 600 via a direct connection or via a network.

As illustrated in FIG. 6, data repository 640 includes live map(s) 642, discovered list(s) 644, good color(s) 646, load barrier(s) 648, store barrier(s) 650, reached-by-data structure(s) 652, resurrected set(s) 654, and remembered set(s) 656. Information describing live map(s) 642, discovered list(s) 644, good color(s) 646, load barrier(s) 648, store barrier(s) 650, reached-by-data structure(s) 652, resurrected set(s) 654, and remembered set(s) 656 may be implemented across any of the components within system 600 (those depicted in FIG. 6 or otherwise). However, this information is illustrated within data repository 640 for purposes of clarity and explanation.

In an embodiment, a live map 642 records the state of runtime object(s) 616 residing in memory area 610. An example live map 642 is a bit map that indicates (a) if a runtime object 616 is live, (b) if the runtime object 616 is strongly reachable, and/or (c) other state information of the runtime object 616. A live map 642 may describe the state of runtime objects 616 throughout memory area 610, the state of runtime objects 616 residing in a particular generation 612 of memory area 610, the state of runtime objects 616 residing in a particular region 614 of memory area 610, and/or the state of runtime objects 616 residing in some other subdivision of memory area 610. If a runtime object 616 is marked as live and/or strongly reachable in a live map 642 during a garbage collection cycle, that runtime object 616 is typically treated as non-disposable for the remainder of that garbage collection cycle. Based on a live map 642, a garbage collector may (a) determine whether or not a reference object should be cleared, (b) select a candidate region 614 to be subjected to relocation operations, (c) identify a runtime object 616 that should be relocated, (d) identify a runtime object 616 that should be collected, and/or (e) perform other collection operations. Whether or not a runtime object 616 is marked as live in a live map 642 may depend on the runtime object's reachability status. In an example, a runtime object 616 is marked as live in a live map 642 if that runtime object is strongly reachable or finalizably reachable. Note that in this example, a finalizably reachable object may need to be retained in memory area 610 until the corresponding finalizer method has been executed. Additionally, or alternatively, the runtime object 616 of this example may be marked as live if that runtime object 616 is softly reachable. Note that whether or not a softly reachable object is marked as live may depend on various factors (e.g., a discovery policy, memory pressure, etc.). If the runtime object 616 is phantom reachable in this example, the runtime object 616 is not marked as live in the live map 642. However, it should be noted that (a) factors other than a runtime object's 616 reachability status may control whether or not the runtime object 616 is marked as live and/or strongly reachable in a live map 642, and (b) a runtime object 616 being marked as live in a live map 642 is not necessarily a reliable indicator of the runtime object's 616 actual state. If a garbage collector discerns any reason for a runtime object 616 to be exempted from collection, the garbage collector may designate that runtime object 616 as live and/or strongly reachable in a live map 642 regardless of whatever the runtime object's 616 actual reachability status may be.

In an embodiment, a discovered list 644 is a list of reference object(s) that may be eligible for reference processing. A discovered list 644 may include soft reference objects, weak reference objects, final reference objects, phantom reference objects, and/or other reference objects. In general, a reference object may be eligible for reference processing if the reference object's referent is not strongly reachable. In an example, a discovered list 644 is generated by a garbage collector during a marking phase while the garbage collector is marking through (a) strongly reachable objects and (b) finalizably reachable objects. Note that a discovered list 644 may be updated during a reference processing phase prior to the system processing any constituent reference objects of the discovered list 644 (e.g., to reflect a resurrection). It should also be noted that a reference object's (e.g., a soft refence object) eligibility for inclusion in a discovered list 644 may depend on a discovery policy that is being applied during a garbage collection cycle. As used herein, a “discovery policy” refers to a rule set for generating record(s) of state information.

In an embodiment, a good color 646 is a value that is used for coloring pointers that refer to runtime objects 616. Good colors 646 may be stored to global variables, stored to thread-local variables, encoded into barriers, and/or maintained in any other location that is readily accessible to a program thread 620 and/or a garbage collector thread 630. Note that during a garbage collection cycle, a garbage collector may determine new good colors 646. For example, a garbage collector may determine new good colors 646 to track a new concurrent phase of a garbage collection cycle. When a garbage collector determines new good colors 646, the previous good colors 646 become bad colors. Recall that, “coloring a pointer” refers to embedding metadata into unused bit(s) within the pointer. For example, a garbage collector may color a pointer by embedding a good color 646 into bits within the pointer that are not being used for storing an address associated with a runtime object 616. The coloring of a pointer may correspond to a state designation that is defined by a monotonic state machine. Note that based on the coloring of a pointer (i.e., the presence and/or the absence of good colors 646 stored to the pointer), a garbage collector can make inferences about the state of a pointer and/or the state of a runtime object that is referred to by the pointer with respect to a garbage collection cycle targeting memory area 610. Additional embodiments and/or examples related to using good colors 646 to color a pointer are described below in Section 6 titled “Colored Pointer Architecture.”

In an embodiment, a barrier (e.g., a load barrier 648 or a store barrier 650) is an additional set of machine-level instructions that is inserted into the machine-level code that is performed by an execution environment. Barriers may be imposed on program threads 620, garbage collector threads 630, and/or other execution environments. By imposing a barrier on a thread, system 600 compels that thread to perform additional operations. For example, the system 600 temporarily commandeers a program thread 620 for performing collection operations by imposing a barrier on that program thread 620. The system 600 often imposes barriers on program threads 620 during concurrent phases. In addition to serving other purposes, the collection operations required by the barriers imposed on program threads 620 contribute to system 600 preventing concurrency issues that might otherwise occur due to program threads 620 performing program operations in the memory area 610 during a concurrent phase. However, note that imposing a barrier on a program thread 620 may adversely affect the performance of a program instance proportional to the time and resources that are spent while the program thread 620 is performing collection operations required by the barrier instead of program operations requested by the program instance. It should also be noted that barriers may be imposed frequently on a program thread 620. For instance, a barrier may be imposed on a program thread 620 for any program operation requested by a program instance that involves loading information from runtime memory or storing information to runtime memory while a concurrent phase is ongoing. Considering that some concurrent phase is often ongoing for a vast majority of a program instance's runtime, even a slight increase to the computational cost of individual barriers may correspond to an unacceptable determinant to the performance of a program instance. The system 600 makes the imposition of barriers on program threads 620 feasible by reducing the computational intensity of barriers in numerous way. For instance, to prevent a program thread 620 from having to search elsewhere in memory to retrieve the inputs that are required by a barrier's logic, the system may (a) encode required inputs for barrier logic into a pointer that the program thread 620 has already loaded while performing a corresponding program operation (i.e., coloring the pointer) and (b) encode other required inputs for barrier logic into the barrier itself (e.g., the current good colors 646). Furthermore, by strictly enforcing monotonic changes to the coloring of the pointers (i.e., monotonic transitions between state designations) during a concurrent phase, the system 600 greatly reduces the complexity (and therefore the cost) of the collection operations that need to be performed by the program threads 620 pursuant to barriers.

In an embodiment, a load barrier 648 is a barrier that is imposed on a thread that is attempting a load operation in memory area 610. More specifically, a load barrier 648 is an additional set of machine-level instructions inserted into the machine-level code that is being executed by a thread proximate to a load operation that is requested in the machine-level code. An example load operation is a request by a program instance for a program thread 620 to read a reference that is carried in an object field of a runtime object 616. A load barrier 648 may be imposed on a program thread 620 if the program thread 620 attempts a load operation during a concurrent phase. Depending on the circumstances, a load barrier 648 may require a program thread 620 attempting a load operation to perform collection operations before and/or after the load operation. The specific collection operations that a load barrier 648 compels a program thread 620 attempting a load operation to perform may depend on the coloring of a pointer that is involved in the load operation. Note that the system may impose different load barriers 648 during different concurrent phases. For example, a load barrier 648 imposed during a concurrent marking phase may require different collection operations than a load barrier 648 imposed during a concurrent reference processing phase or a load barrier 648 imposed during a concurrent relocation phase. Example collection operations that may be performed by a program thread 620 pursuant to a load barrier 648 include (a) striping bad colors from a pointer, (b) relocating a runtime object, (c) remapping a pointer, (d) coloring a pointer, (e) adding an entry to the marking stack of a garbage collector thread 630, (f) adding an entry to a resurrected set 654, (f) blocking a program instance from dereferencing a reference object, and (g) other collection operations. Additional embodiments and/or examples relating to a load barrier 648 are described below in Section 8.1, titled “Example Load Barrier.”

In an embodiment, a store barrier 650 is a barrier that is imposed on a thread that is attempting a store operation in memory area 610. More specifically, a store barrier 650 is an additional set of machine-level instructions inserted into the machine-level code that is being executed by a thread proximate to a store operation that is requested in the machine-level code. An example store operation is a request by a program instance for a program thread 620 to store a reference to an object field of a runtime object 616. A store barrier 650 may be imposed on a program thread 620 if the program thread 620 attempts a store operation during a concurrent phase. Depending on the circumstances, a store barrier 650 may require a program thread 620 attempting a store operation to perform collection operations before and/or after the store operation. The specific collection operations that a store barrier 650 compels a program thread 620 to perform may depend on the coloring of a pointer that is involved in the store operation. Note that the system 600 may impose different store barriers 650 during different concurrent phases. For example, a store barrier 650 imposed during a concurrent marking phase may require different collection operations than a store barrier 650 imposed during a concurrent reference processing phase or a store barrier 650 imposed during a concurrent relocation phase. Example collection operations that may be performed by a program thread pursuant to a store barrier 650 include (a) adding an entry to a store barrier buffer, (b) adding an entry to a remembered set 656, (c) relocating a runtime object, (d) remapping a pointer, (e) coloring a pointer, (f) adding an entry to the marking stack of a garbage collector thread 630, and/or (g) other collection operations. Additional embodiments and/or examples relating to store barriers 650 are described below in Section 8.2, titled “Example Store Barrier.”

In an embodiment, a reached-by-data structure 652 records state information of a runtime object 616 that could be resurrected during a garbage collection cycle. In particular, a reached-by-data structure 652 records state information associated with a runtime object 616 that can be used to update other records of state information (e.g., a live map 642, a discovered list 644, colored pointers, a remembered set 656, etc.) in the event that the runtime 616 is resurrected. Recall that the term “resurrection” refers to an upgrade to a runtime object's 616 reachability status. For example, a resurrection occurs when a runtime object 616 that was formerly softly reachable, weakly reachable, finalizably reachable, phantom reachable, or unreachable becomes strongly reachable.

In an embodiment, a resurrected set 654 is a list of resurrections. A resurrected set 652 is used by a garbage collector to identify resurrections that occurred during a termination procedure for a concurrent marking phase. Based on a resurrected set 654, a garbage collector can identify any reached-by-data structures 652 that will be needed to update other records of state information in view of any resurrections that occurred during a termination procedure. Note that a resurrected set 654 can be used by a program thread 620 executing a load barrier to determine if a runtime object 616 was resurrected during a termination procedure even if the system 600 has not yet updated other records of state information (e.g., a live map 642) to reflect the resurrection. An example resurrected set 654 is a list of reference objects that are used to resurrect the reference object's referents during a termination procedure for a concurrent marking phase of a garbage collection cycle. The example resurrected set 654 is generated by at least one program thread 620 while executing a barrier. Specifically, the example resurrected set 654 is generated by any program threads that performed the program operations resulting in the resurrections listed in the example resurrected set 652. In other words, the example resurrected set 652 is generated by mutators during the termination procedure.

In an embodiment, memory area 610 includes multiple generations 612, and a remembered set 656 is a list of object fields that hold references that potentially cross generational boundaries within memory area 610. For example, an object field of a runtime object 616 may be added to remembered set 656 if (a) that runtime object resides in an old generation 612 of the memory area 610 and (b) the field holds a reference to another runtime object 616 that potentially resides in a young generation 612 of the memory area 610. Note that a cross generational reference is typically treated as a root. In an example, a program thread adds an object field of a runtime object 616 to a remembered set 656 while performing a store barrier 650. In this example, the program thread 620 is made to perform the store barrier 650 due to a program instance requesting that a new reference be stored to the object field of the runtime object 616 (i.e., a store operation).

### 4. Garbage Collection Cycle

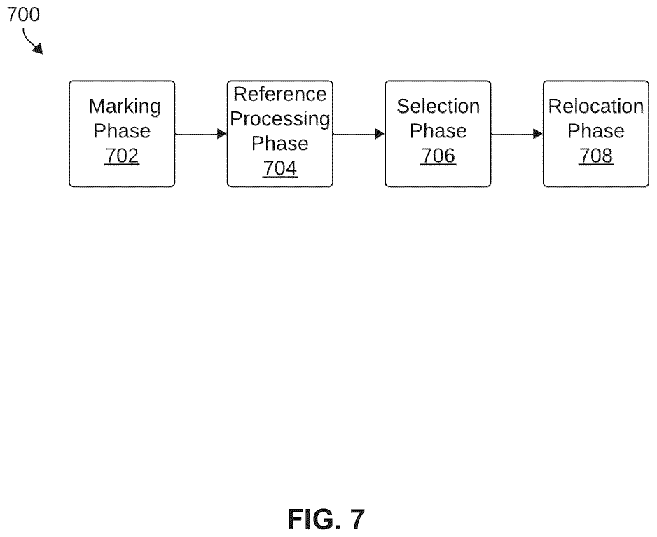

FIG. 7 illustrates an example architecture for a garbage collection cycle 700 in accordance with one or more embodiments. As illustrated in FIG. 7, garbage collection cycle 700 may include marking phase 702, reference processing phase 704, selection phase 706, and relocation phase 708. In one or more embodiment, garbage collection cycle 800 may include more or fewer phases than the phases illustrated in FIG. 7, and/or one or more phases illustrated in FIG. 7 may be modified, rearranged, or omitted all together. Accordingly, the particular sequence of operations illustrated in FIG. 7 should not be construed as limiting the scope of one or more embodiments. Furthermore, it should be understood that a garbage collection 700 may include collection operations that do not occur during any particular phase of the garbage collection cycle 700. For example, collection operations may occur before, after, and/or in between phases of a garbage collection cycle 700.

In an embodiment, garbage collection cycle 700 is a concurrent garbage collection cycle. Therefore, at least one phase of garbage collection cycle 700 (e.g., marking phase 702, reference processing phase 704, selection phase 706, relocation phase 708, etc.) is a concurrent phase. During an example concurrent phase of garbage collection cycle 700, a garbage collector thread is performing collection operations in a memory area while at least one program thread is simultaneously enabled to perform program operations in the memory area. If left unchecked, program operations interfering with collection operations during a concurrent phase can result in concurrency issues, such as race conditions, livelock, deadlock, data corruption, memory loss, termination indeterminism, and other problems. In general, the system prevents concurrency issues from arising during a concurrent phase of garbage collection cycle 700 using a combination of a monotonic state machine, pointer coloring, barriers, reached-by-data structures, a resurrected set, and other mechanisms.

In an embodiment, garbage collection cycle 700 includes a marking phase 702. During the marking phase 702, the system marks through runtime objects residing in a memory area to collect state information. While marking through the runtime objects, the system generates records of state information that will be used in subsequent phases of the garbage collection cycle 700 as a basis for collecting runtime objects from the memory area, retaining runtime objects in the memory area, reorganizing the memory area, and/or other collection operations. Example records of state information that may be generated during the marking phase 702 include live maps, discovered lists, colored pointers, reached-by-data structures, remembered sets, resurrected sets, and others. The system may generate a record of state information in accordance with a discovery policy that is selected by the system based on conditions within the memory area, characteristics of a program instance manipulating the memory area, and/or other inputs. In addition to generating records of state information, the system may perform other marking operations during the marking phase 702. For example, if the system encounters a broken pointer while marking through a runtime object, the system repairs the broken pointer by remapping the broken pointer to the correct address. The system may continue to repair broken pointers that are encountered by the system throughout garbage collection cycle 700.

In an embodiment, marking phase 702 is a concurrent phase of garbage collection cycle 700. Thus, during marking phase 702, program operations may be manipulating the memory area at the same time as the system is performing marking operations in the memory area. Note that program operations manipulating the memory area may further complicate marking phase 702. For instance, if a program operation alters the reachability status of a runtime object residing in the memory area during marking phase 702, the system may be forced to repeat marking operations, and/or the system may be forced to perform additional marking operations.

In an embodiment, marking phase 702 is a snapshot-at-the-beginning (SATB) marking phase, an incremental marking phase, and/or another type of concurrent marking phase. In an example, marking phase 702 is implemented as an SATB phase. As the name suggests, an SATB marking phase begins with the system generating a snapshot of a memory area that is being subjected to a garbage collection cycle. Based on the snapshot, the system identifies root objects residing in the memory area. Starting from the root objects, the system traverses strong references to other strongly reachable objects until no more strongly reachable objects can be found within the memory. In addition to marking through the strong object graph of the memory area in this example, the system marks through runtime objects residing in the memory area that are reachable but less than strongly reachable. For instance, the system may mark through finalizably reachable objects as finalizably reachable objects may need to be retained in the memory area for a corresponding finalizer method to be successfully executed. Furthermore, while generating reached by data structure(s), the system may mark through other runtime objects that could potentially be resurrected. To this end, the system may mark through a part of the runtime objects that could potentially be resurrected, or the system may mark through all of the runtime objects that could potentially be resurrected. Recall that whether or not a referent of a reference object can be resurrected may depend on whether or not that reference object is dereferenceable. In an example application, soft reference objects, weak reference objects, and native weak reference objects are typically dereferenceable prior to clearing. Therefore, in this example application, a runtime object may be a candidate for marking by the system if that runtime object is reachable through at least one chain of reference(s) that (a) includes a soft reference, a weak reference, and/or a native weak reference and (b) does not include a phantom reference. Note that the system need not traverse the object graph to discover native weak references in this example as a native weak reference is automatically discovered upon creation. It should also be noted that this example does not describe an exhaustive list of reference objects, and recall that reachability through a native weak reference object is considered of equal strength to phantom reachability. Further recall that any reference object may be configured to be dereferenceable or non-dereferenceable. For example, while a get( ) method of a phantom reference object is often configured to return null, a get method( ) of a phantom reference object can be configured to return the phantom reference object's referent. In sum of the foregoing, the reachability status of a runtime object is not necessarily a definitive indicator of whether or not that runtime object is a candidate for marking and the reachability statuses of runtime objects that are candidates for marking may vary between applications. In general, any runtime object that could potentially be resurrected is a candidate for marking during marking phase 702 while the system is generating reached by data structure(s).

In an embodiment, garbage collection cycle 700 includes a reference processing phase 704. During reference processing phase 704, the system processes reference objects residing in the memory area. In particular, the system may process reference object(s) that are included in a discovered list. Examples of reference objects that may be found in a discovered list include soft reference objects, weak reference objects, final reference objects, phantom reference objects, and others. Note that a discovery policy that is applied during marking phase 702 may impact the contents of a discovered list, a live map, and/or other records of state information. It should also be noted that before processing the reference objects included in a discovered list, the system may update the discovered list during reference processing phase 704. Once any appropriate updates are applied to a discovered list, the system iterates through the discovered list processing the constituent reference objects. Processing a reference object may entail clearing the reference object, enqueueing the reference object, and/or other reference processing operations. A reference object is cleared by setting the referent field of the reference object to null. Clearing a reference object breaks the non-strong reference that links the reference object to the reference object's referent. Once a reference object has been cleared, the reference object cannot be dereferenced; therefore, that reference object can no longer be used to resurrect the reference object's referent. When a reference object is cleared, the reference object's referent will typically become unreachable unless the referent is also referred to by another reference object. Consequently, clearing a reference object usually results in the reference object's referent being collected during the present garbage collection cycle 700 or a subsequent garbage collection cycle. The system may clear any reference object that is included in a discovered list; however, the system may refrain from clearing a final reference object if the final reference object's referent possesses an uncalled finalizer method. Enqueueing a reference object adds the reference object to an appropriate reference queue. Adding a reference object to a reference queue serves to notify any program instance associated with the reference object that the referent has been collected or will soon be collected. Notifying a program instance of a referent being subjected to collection may signal the program instance to take appropriate actions, such as performing cleanup operations, logging, and/or other post-mortem processing.

In an embodiment, reference processing phase 704 is a concurrent phase of garbage collection cycle 700. Thus, during reference processing phase 704, program operations may be attempting to manipulate reference objects at the same time that the system is attempting to process those reference objects. Note that a program operation manipulating a reference object might interfere with an attempt to process that reference object. For example, concurrency issues might arise if a program operation is allowed to resurrect a reference object included in a discovered list while the system is attempting to process reference objects in the discovered list.

In an embodiment, garbage collection cycle 700 includes selection phase 706. During selection phase 706, the system generates an evacuation candidate set. The evacuation candidate set contains candidate regions. A candidate region is a region of the memory area that may be targeted by a relocation phase 708 of the garbage collection cycle 700. The system selects a candidate region based on records of state information originally generated during the marking phase (e.g., a live map), and/or the system selects the candidate region based on other information. Example inputs that potentially influence the selection of a candidate region by the system include an occupancy level of the candidate region, a capacity of the candidate region, the amount of live object in the candidate region, the amount of dead objects in the candidate region, and other information. In an example, the system selects a candidate region based on a liveness ratio associated with runtime objects residing in the candidate region. In this example, the system calculates the liveness ratio based on a live map that was generated during the marking phase 702, and the candidate region is selected because the liveness ratio indicates that the candidate region has proportionally fewer live objects relative to other regions.

In an embodiment, garbage collection cycle 700 includes relocation phase 708. During relocation phase 708, the system relocates non-disposable runtime objects residing in the candidate regions that are identified in an evacuation candidate set. The non-disposable runtime objects residing in the candidate regions are relocated to other non-candidate regions of the memory area. In general, a runtime object residing in a candidate region may be relocated if that runtime object is marked as live and/or strongly reachable in a live map and/or another record of state information. When the system relocates a runtime object, the system generates an entry for that runtime object in a forwarding table. An example entry in a forwarding table maps the previous address of a runtime object that formerly resided in a candidate region to a post-relocation address of that runtime object in a non-candidate region. In addition to relocating runtime objects and generating a forwarding table, the system may perform other collections operations while relocating the runtime objects. For example, in addition to relocating a runtime object, the system may remap a pointer that refers to that runtime object to the runtime object's new location in the memory area. Furthermore, the system tracks the progression of the relocation phase by coloring pointers that refer to the relocated runtime objects. Once the system has completed relocating the non-disposable runtime objects residing in a candidate region, the system reclaims the memory associated with that candidate region. The disposable runtime objects that are not relocated from a candidate region are effectively collected by the system when the memory allocated to that candidate region is reclaimed.

In an embodiment, relocation phase 708 is a concurrent phase of garbage collection cycle 700. Thus, during relocation phase 708, program operations may be attempting to manipulate runtime objects residing in a candidate region while the system is attempting to perform relocation operations in the candidate region.

### 5. Monotonic State Machine

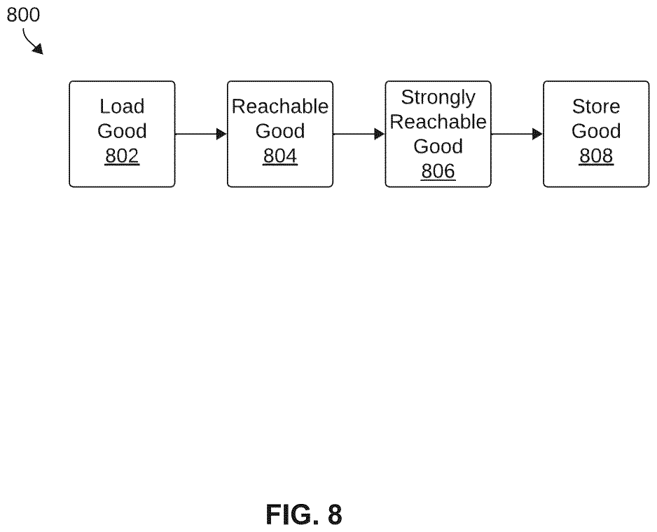

FIG. 8 illustrates an example architecture for a state machine 800 in accordance with one or more embodiments. During a garbage collection process targeting a memory area, state machine 800 is used to model the processing of pointers that refer to runtime objects residing in the memory area. For the purposes of clarity and understanding, state machine 800 is generally described below with respect to a single pointer (referred to as “the pointer”) that refers to a specific runtime object (referred to as “the target object”) residing in the memory area. However, it should be understood that state machine 800 may be employed to track the processing of any given pointer to a runtime object residing in the memory area during the garbage collection process. As illustrated in FIG. 8, state machine 800 may include multiple distinct state designations, such as load good 802, reachable good 804, strongly reachable good 806, and/or store good 808. In one or more embodiments, state machine 800 may include more or fewer state designations than the state designations illustrated in FIG. 8, and/or one or more state designations illustrated in FIG. 8 may be modified, rearranged, or omitted.

In an embodiment, the processing of the pointer during a concurrent phase is modeled according to state machine 800. At any point during the concurrent phase, the pointer's state may correspond to a state designation defined by state machine 800 (e.g., no state designation, load good 802, reachable good 804, strongly reachable good 806, or store good 808). Furthermore, changes to the pointer's state during the concurrent phase may be conceptualized as transitions between state designations defined by state machine 800. For instance, when the system first encounters the pointer during the concurrent phase, the system may assign the pointer an initial state designation corresponding to the pointer's initial state. As the concurrent phase continues and the pointer's state is changed, the change to the pointer's state can be conceptualized as a transition from the initial state designation to another state designation.

In an embodiment, state machine 800 is a monotonic state machine. Thus, transitions between state designations of state machine 800 will occur in a single direction during a concurrent phase. For example, if the pointer is assigned a former state designation during a concurrent phase, the pointer may be transitioned to a latter state designation during the concurrent phase. However, if the pointer is transitioned to the latter state designation in this example, the pointer cannot be transitioned backwards to the former state designation during the concurrent phase. The inability of the pointer to revert to a previous state designation during a concurrent phase simplifies coordinating concurrent operations, and the guarantee that the state of any given pointer evolves in one direction translates into broader guarantees regarding the progression of the concurrent phase. Furthermore, the inability of a pointer to revert to a previous state designation may altogether prevent a concurrency issue (e.g., race conditions, deadlock, livelock, etc.) that might otherwise occur due to a garbage collection process and a program instance requesting opposing changes to the pointer's state.

In an embodiment, the pointer's current state designation according to state machine 800 is tracked by coloring the pointer during a concurrent phase. For example, an initial state designation may be assigned to the pointer by storing a good color to a set of unused bits within the pointer, and the pointer may be transitioned to a new state designation by storing another good color to another set of unused bits within the pointer. Recall that transitions between state designations are monotonic during a concurrent phase; therefore, the coloring of the pointer is also monotonic during the concurrent phase. Additional embodiments and/or examples related to pointer coloring are described below in Section 6 titled “Colored Pointer Architecture.”

In an embodiment, state machine 800 is reset during a garbage collection cycle. In particular, state machine 800 may be reset prior to a concurrent phase of the garbage collection cycle. In an example, state machine 800 is reset prior to a concurrent marking phase, and state machine is reset prior to a concurrent relocation phase. If state machine 800 is reset, the pointer loses any state designation that was previously assigned to the pointer during an ongoing garbage collection cycle or a prior garbage collection cycle. The system may reset state machine 800 by determining new good colors for pointer coloring.

In an embodiment, the pointer qualifies as load good 802 if the pointer stores the correct address. For example, the pointer may qualify as load good 802 if the pointer holds an address that is associated with the target object's current location in memory and/or intended location in memory. In other words, the pointer qualifies as load good 802 if the pointer does not need to be remapped. The pointer may need to be remapped if the target object was relocated by a garbage collection process during an ongoing garbage collection cycle or a prior garbage collection cycle. If the pointer is designated load good 802, the runtime object does not lose the load good 802 designation until state machine 800 is reset. Note that if the pointer qualifies as load good 802 while referring to one target object, the pointer will still qualify as load good 802 if the pointer is remapped to a different target object.

In an embodiment, the pointer qualifies as reachable good 804 if (a) the pointer qualifies as load good 802 and (b) the target object is reachable. The target object is reachable if the target object is strongly reachable, softly reachable, weakly reachable, finalizably reachable, or phantom reachable. Accordingly, the pointer being designated reachable good 804 does not necessarily imply that the target object possesses any specific reachability status. If the pointer is designated reachable good 804, the pointer does not lose the reachable good 804 designation until state machine 800 is reset. Note that if the pointer is designated as reachable good 804, the target object may or may not be collected by an ongoing garbage collection cycle. If the memory area includes multiple generations, the pointer may be considered reachable good 804 with respect to multiple generations. Furthermore, the pointer may be designated reachable good 804 with respect to one generation, and the pointer may not be designated reachable good 804 with respect to another generation. In an example, the pointer is designated as reachable good 804 with respect to a young generation, and/or the pointer is designated as reachable good 804 with respect to an old generation.

In an embodiment, the pointer qualifies as strongly reachable good 806 if (a) the pointer qualifies as reachable good 804 and (b) the target object is strongly reachable. If the pointer is designated strongly reachable good 806, the pointer does not lose the strongly reachable good 806 designation until state machine 800 is reset. Note that if the pointer is designated as strongly reachable good 806 during a garbage collection cycle, the target object is typically not collected by that garbage collection cycle. If the memory area includes multiple generations, the pointer may be considered strongly reachable good 806 with respect to multiple generations. Furthermore, the pointer may be designated strongly reachable good 806 with respect to one generation, and the pointer may not be designated strongly reachable good 806 with respect to another generation. In an example, the pointer is designated as strongly reachable good 806 with respect to a young generation, and/or the pointer is designated as reachable good 804 with respect to an old generation.

In an embodiment, the pointer qualifies as store good 808 if (a) the pointer qualifies as strongly reachable good 806 and (b) a store operation requested by a program instance has been performed on the pointer since state machine 800 was last reset. Additionally, or alternatively, if the memory area is organized into multiple generations, the pointer may be designated as store good 808 if (a) the pointer qualifies as strongly reachable good 806 and (b) an object field that carries the reference corresponding to the pointer does not need to be added to a remembered set. If the pointer is designated as store good 808, the pointer does not lose the store good 808 designation unless state machine 800 is reset.

### 6. Colored Pointer Architecture

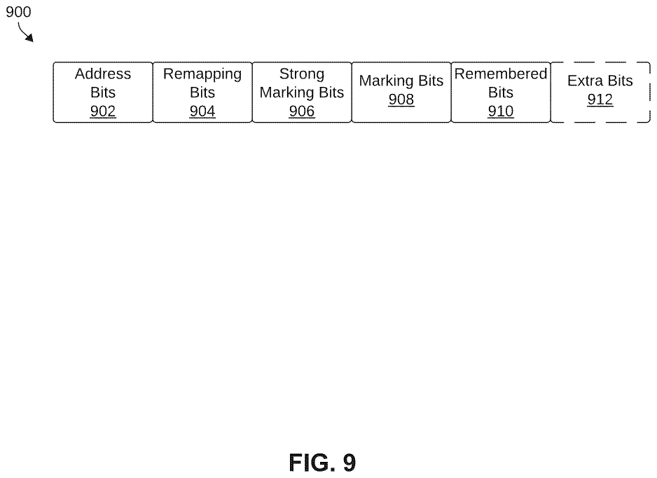

FIG. 9 illustrates an example pointer 900 in block diagram form in accordance with one or more embodiments. Pointer 900 refers to a runtime object (referred to as “the target object”) residing in a memory area that is being subjected to a garbage collection process. More specifically, pointer 900 holds an address of a location in memory that is associated with the target object. As illustrated in FIG. 9, pointer 900 may include address 902, remapping bits 904, strong marking bits 906, marking bits 908, remembered bits 910, and/or extra bits 912. In one or more embodiments, pointer 900 may include more or fewer components than the components illustrated in FIG. 9, and/or one or more components of pointer 900 as illustrated in FIG. 9 may be modified, rearranged, or omitted all together.

In an embodiment, pointer 900 is a cluster of bits in low-level memory. Pointer 900 is used to implement, at least in part, a reference (referred to as the “corresponding reference”) to the target object. The corresponding reference is carried in an object field of another runtime object residing in the memory area, or the corresponding reference resides elsewhere. If (a) the corresponding reference 900 originates from the memory area and (b) the memory area includes multiple generations, the corresponding reference may originate from the same generation that the target object resides in, or the corresponding reference may originate from a different generation than the generation that the target object resides in. The corresponding reference is a strong reference, or the corresponding reference is a non-strong reference.

In an embodiment, address bits 902 is a set of bits within pointer 900 that stores an address of a location in memory associated with the target object. Note that the address stored to address bits 902 may change during the course of a garbage collection cycle. In an example, the target object is relocated during a garbage collection cycle, and the value stored to address bits 902 is updated to reflect the target object's new location within the memory area. In another example, a program thread, while performing a program operation, updates the address stored to address bits 902, so the corresponding reference subsequently refers to a different runtime object.

In an embodiment, the coloring of pointer 900 describes the state of pointer 900, and/or the coloring of pointer 900 describes the state of the target object. With respect to FIG. 9, the “coloring of pointer 900” refers to the values carried by remapping bits 904, strong marking bits 906, marking bits 908, remembered bits 910, and/or extra bits 912. Apart from address bits 902, any given set of bits within pointer 900 may hold a good color, a bad color, or no color. The coloring of pointer 900 enables a garbage collector (e.g., a garbage collector thread or a program thread executing a barrier) to make inferences about the progression of a garbage collection cycle with respect to the pointer 900 without having to access state information stored in a separate location. As a result, the computational cost of certain collection operations is reduced. As an example, assume that a program thread, while performing a program operation, loads the corresponding reference. In effect, loading the corresponding reference stores pointer 900 onto the program thread's virtual machine stack. In this example, the program thread is made to perform a barrier corresponding to the program operation, and the program thread is able to determine the collection operations that are required by the barrier based on the coloring of the pointer 900 that the program thread has already stored to the virtual machine stack while performing the program operation. As a result, the program thread avoids the computational cost that would be associated with the program thread having to obtain state information of the pointer 900 and/or the target object from another location. Therefore, the barrier's impact on the performance of the program instance is reduced.

In an embodiment, the coloring of pointer 900 corresponds to a state designation of a monotonic state machine. For instance, a former state designation may correspond to one good color being stored to pointer 900, and a latter state designation may correspond to two good colors being stored to pointer 900. Recall that a monotonic state machine only allows monotonic transitions between state designations during a concurrent phase. Accordingly, changes to the coloring of pointer 900 are also monotonic during a concurrent phase. During a concurrent phase, the machine-level instructions that are executed by program threads and garbage collector threads do not permit a good color to be removed from pointer 900 during a concurrent phase; only additional good colors can be added to pointer 900 during the concurrent phase. Stated differently, the coloring of pointer 900 can only become more good during the concurrent phase. Enforcing monotonic color changes to pointer 900 (i.e., monotonic transitions between state designations) simplifies the logic that needs to be executed by a garbage collector (e.g., a garbage collector thread or a program thread executing a barrier) while performing collection operations during a concurrent phase. Therefore, the overall impact of a garbage collection process on the performance of a program instance is reduced.

In an embodiment, remapping bits 904 indicate if address bits 902 store a correct address of the target object. If remapping bits 904 hold a good color, a garbage collector can conclude that address bits 902 stores the correct address, and pointer 900 does not need to be remapped. As used herein, pointer 900 is said to be “colored load good” if remapping bits 904 hold a good color. Alternatively, if remapping bits 904 do not hold a good color, pointer 900 is said to be “colored load bad.” Note that pointer 900 being colored load bad is not, in itself, a sufficient basis for inferring that address bits 902 stores an incorrect address. If pointer 900 is colored load bad, address bits 902 stores the correct address, or address bits 902 stores an incorrect address. Notwithstanding, the system may draw other conclusions from remapping bits 904 storing a bad color. For instance, remapping bits 904 storing a bad color may serve as a sole basis for concluding that pointer 900 has not been subjected to any collection operations since good colors were last updated (i.e., when a state machine was last reset). It should also be noted that the coloring of remapping bits 904, in combination with the other indicia, may serve as a foundation for other inferences.

In an embodiment, strong marking bits 906 indicate if the target object should be treated as strongly reachable. If strong marking bits 906 hold a good color, a garbage collector that interacts with pointer 900 may treat the target object as strongly reachable. As used herein, pointer 900 is said to be “colored strongly reachable good” if (a) a good color is stored to remapping bits 904, (b) a good color is stored to marking bits 908, and (c) a good color is stored to strong marking bits 906. Alternatively, a pointer 900 is said to be “colored strongly reachable bad” if a bad color or no color is stored to strong marking bits 906. Note that if the memory area includes multiple generations, pointer 900 may include a separate set of strong marking bits 906 for each generation of the memory area that may be subjected to a garbage collection cycle. In an example, the memory area includes a young generation and an old generation. In this example, pointer 900 includes a set of strong marking bits 906 for the young generation (referred to herein as the “young strong marking bits”), and pointer 900 includes a set of strong marking bits 906 for the old generation (referred to herein as the “old strong marking bits”).

In an embodiment, marking bits 908 indicate if the target object should be treated as reachable. If marking bits 908 hold a good color, a garbage collector that encounters the target object through pointer 900 treats the target object as reachable. If (a) remapping bits 904 hold a good color and (b) marking bits 908 hold a good color, pointer 900 is said to be “colored reachable good.” Alternatively, pointer 900 is said to be “colored reachable bad” if a bad color or no color is stored to marking bits 908. If the memory area includes multiple generations, pointer 900 may include a separate set of marking bits 908 for each generation of the memory area. In an example, the memory area includes a young generation and an old generation. In this example, pointer 900 includes a set of marking bits 908 for the young generation (referred to herein as the “young marking bits”), and pointer 900 includes a set of marking bits 908 for the old generation (referred to herein as the “old marking bits”). Note that, unlike strong marking bits 906, marking bits 908 do not track a specific reachability status. Recall that a runtime object is reachable if the runtime object is strongly reachable, softly reachable, weakly reachable, finalizably reachable, or phantom reachable. Further note that tethering the coloring of marking bits 908 to a specific reachability status would be problematic for implementing a monotonic state machine. As an example, pretend that marking bits 908 are instead used to more specifically indicate if the target object is finalizably reachable. Recall that a finalizably reachable object is inherently not strongly reachable. Therefore, marking bits 908 and strong marking bits 906 could not both hold a good color in this example. If marking bits 908 and strong marking bits 906 both held a good color in this example, the coloring of pointer 900 would suggest that the target object has two conflicting reachability statuses (i.e., finalizably reachable and strongly reachable), and the appropriate manner for processing pointer 900 and/or the target object might be uncertain as a consequence. Because a good color cannot be stored to both of marking bits 908 and strong marking bits 906 in this example, marking bits 908 and strong marking bits 906 would effectively correspond to mutually exclusive state designations that do not fit into a linear architecture of state designations that have stacking requirements. Further, if the target object's reachability status were to be upgraded from finalizably reachable to strongly reachable in this example (e.g., as a result of a finalizer method of the target object being executed), expressing that change to the target object's reachability status would require removing a good color from marking bits 906 (i.e., a non-monotonic transition between state designations). Furthermore, note that program threads typically do not encounter finalizably reachable objects because program operations do not manipulate finalizably reachable objects; therefore, program threads could not contribute to coloring marking bits 908 in this example. In contrast, using marking bits 908 to track reachability more broadly enables program threads, acting pursuant to barriers, to contribute to coloring marking bits 908 while interacting with runtime objects that are exposed at the program level.

In an embodiment, remembered bits 910 indicate if pointer 900 has been included within a remembered set since the since good colors were last updated (i.e., when the state machine was last reset). Based on remembered bits 910, a garbage collector may also infer if a program thread has stored a different address to address bits 902 while performing a program operation since the state machine was last reset. In an alternative embodiment, remembered bits 910 primarily indicate if a program thread has stored a different address to address bits 902 while performing a program operation since the state machine was last reset. Note that if a program thread remaps pointer 900 while executing a barrier (i.e., a garbage collector remaps pointer 900 while performing a collection operation), the program thread does not store a good color to remembered bits 910. As used herein, pointer 900 is said to be “colored store good” if a) a good color is stored to remapping bits 904, (b) a good color is stored to marking bits 908, (c) a good color is stored to strong marking bits 906, and (d) a good color is stored to remembered bits 910. Alternatively, pointer 900 is said to be “colored store bad” if a bad color or no color is stored to remembered bits 910.

In an embodiment, pointer 900 optionally includes extra bits 912. Whether or not extra bits 912 are included in pointer 900 depends on the total number of bits included in pointer 900 and the number of bits allocated to the other components of pointer 900. Extra bits 912 are optionally encoded with other metadata tracking state information of pointer 900 and/or the target object.

### 7. Monotonic Processing of Pointers

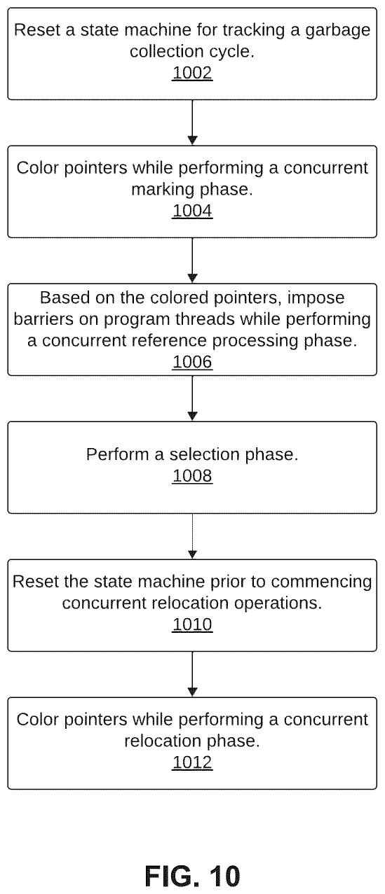

FIG. 10 illustrates example collection operations that may be performed in furtherance of a garbage collection process targeting a memory area in accordance with one or more embodiments. For the purposes of clarity and understanding, collection operations are generally described below with respect to a single garbage collection cycle (referred to as “the garbage collection cycle”) that is presently occurring in the memory area. However, it should be understood that the garbage collection cycle may be one of multiple garbage collection cycles that the system performs during the garbage collection process. Furthermore, note that the system may be performing the garbage collection cycle while the system is also performing other garbage collection cycle(s) in the memory area at the same time. One or more operations illustrated in FIG. 10 may be modified, rearranged, or omitted all together. Accordingly the particular sequence of operations illustrated in FIG. 10 should not be construed as limiting on the scope of one or more embodiments.

In an embodiment, the system resets a state machine for processing pointers during the garbage collection cycle (Operation 1002). The system resets the state machine by determining at least some new good colors for coloring pointers and storing the new good colors to one or more locations where the new good colors can be readily accessed by a program thread and/or a garbage collector thread. Note that the system does not necessarily determine new good colors for all sets of bits that are used for coloring pointers. If the system determines a new good color for a set of bits, the previous good color for that set of bits is rendered bad. Accordingly, in the moment that immediately follows the determination of a new good color for a set of bits, it can be expected that any given pointer that refers to a runtime object residing in the memory area will be colored bad or will be colorless withing that set of bits. It should also be noted that how the state designations of pointers are affected by altering the good colors will depend on what good colors are altered. In some cases, any state designations that were previously assigned to pointers will be lost when the state machine is reset. In other cases, only some state designations that were previously assigned to pointers will be lost when the state machine is reset. The system resets the state machine while program instance(s) are paused, or the system resets the state machine while program instance(s) are running. In an example, the system determines the new good colors during a stop the world phase that immediately precedes the commencement of concurrent marking operations. In this example, the system (a) encodes the new good colors into barriers (e.g., load barriers and store barriers), (b) stores the new good colors to global variables, (c) stores the new good colors into thread-local variables, and/or (d) stores the new good colors to other locations. During the stop the world phase of this example, the system may also perform other collection operations. For instance, the system may generate a snapshot of the memory area that will be used as a starting point for concurrent marking operations in this example.

The system, according to an embodiment, resets the state machine for the garbage collection cycle, and/or the system resets the state machine for other garbage collection cycle(s). Recall that the system may be performing multiple garbage collection cycles in the memory area at the same time. Therefore, to avoid having to coordinate the timing of the multiple garbage collection cycles, the system may maintain separate good colors for the multiple garbage collection cycles. Accordingly, by simply updating a subset of the good colors, the system may reset the state machine for a specific garbage collection cycle. In an example, the memory area includes a young generation and an old generation. In this example, the system is performing one concurrent garbage collection cycle in the young generation, and the system is simultaneously performing another concurrent garbage collection cycle in the old generation at the same time. The system of this example resets the state machine for the one garbage collection cycle, and/or the system resets the state machine for the other garbage collection cycle.

The system, according to an embodiment, resets the state machine prior to a concurrent marking phase by determining new good colors for coloring (a) the strong marking bits of pointers and (b) the marking bits of pointers. Note that determining new good colors for the strong marking bits and the marking bits will result in pointers losing the state designations that require a certain reachability status (i.e., reachable good, strongly reachable good, and store good). In this embodiment, the system does not determine a new good color for coloring the remapping bits of pointers prior to concurrent marking phase. As a result, any pointers that were previously reachable good, strongly reachable good, or store good will be reduced to load good prior to the concurrent marking phase. Recall that if the memory area includes multiple generations, the pointers may include separate sets of bits for the separate generations.

Prior to commencing a concurrent marking phase targeting a young generation of the memory area, the system, according to an embodiment, determines new good colors for coloring (a) the young strong marking bits of pointers, (b) the young markings bits of pointers, and (c) the remembered bits of pointers. Therefore, any pointers that were previously reachable good with respect to the young generation, strongly reachable good with respect to the young generation, and/or store good will lose those state designations. Note that a pointer may retain a reachable good designation with respect to the old generation and/or a strongly reachable good state designation with respect to the old generation if the good colors for the old marking bits and the old strong marking bits remain unchanged.

Prior to commencing a concurrent marking phase in an old generation of the memory area, the system, according to an embodiment, determines new good colors for coloring (a) the old marking bits of pointers and (b) the old strong marking bits of pointers. As a result, pointers that were previously reachable good with respect to the old generation, strongly reachable good with respect to the old generation, or store good may be reduced to load good. Note that a pointer may retain a reachable good designation with respect to the young generation and/or a strongly reachable good state designation with respect to the young generation if the good colors for the young marking bits and the young strong marking bits remain unchanged. It should also be noted that the system need not determine new good colors for the remembered bits prior to the concurrent marking phase targeting the old generation.

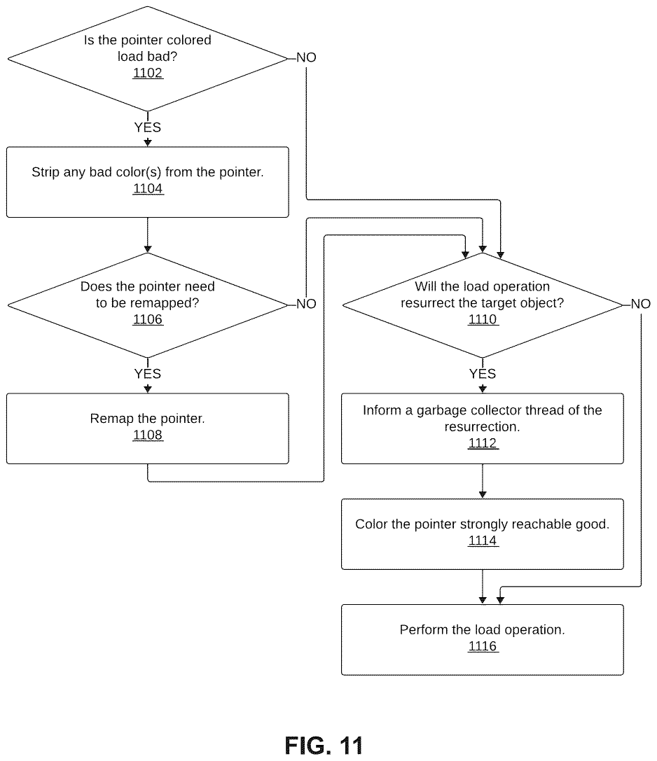

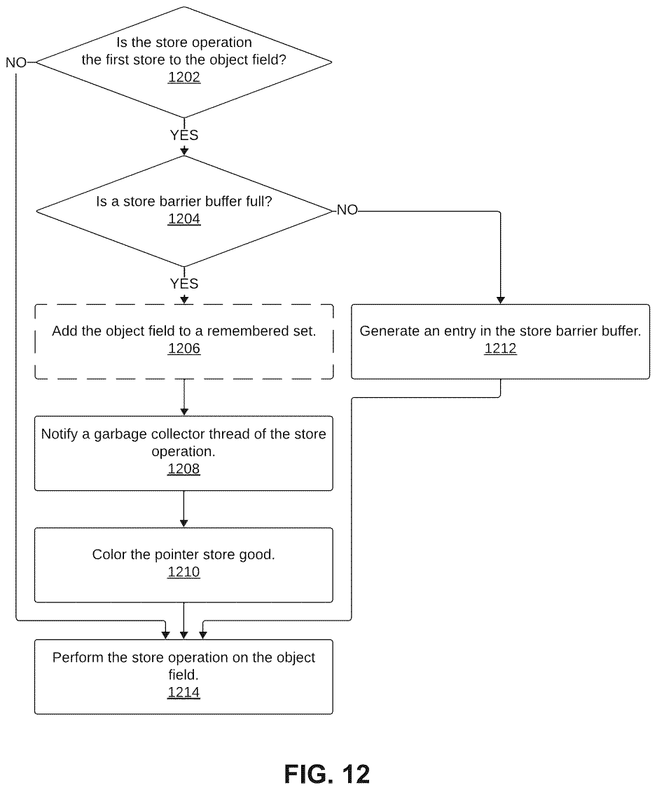

In an embodiment, the system colors pointers while marking through runtime objects residing in the memory area during a concurrent marking phase (Operation 1004). During the concurrent marking phase, at least one garbage collector thread is marking through the memory area to generate records of state information while at least one program thread is concurrently performing program operations in the memory area. A program thread and a garbage collector thread coordinate their activities based on pointer coloring. A garbage collector thread colors pointers while generating other records of state information (e.g., a live map, a discovered list, a reached-by-data structure, etc.), and a program thread colors pointers while performing barriers corresponding to program operations. Recall that, in addition to coloring a pointer, a barrier performed by a program thread may require the performance of various other collection operations. Based on the coloring of a pointer, a program thread executing a barrier corresponding to a program operation can immediately infer what collection operations the program thread will need to perform. Example collection operations that may be performed pursuant to a load barrier that is imposed on a program thread during a concurrent marking phase are described below with reference to FIG. 11, and example collection operations that may be performed pursuant to a store barrier that is imposed on a program thread during a concurrent marking phase are described below with reference to FIG. 12.

The system, according to an embodiment, colors a pointer after remapping the pointer during the concurrent marking phase. As an example, consider a pointer that is intended to refer to a runtime that was relocated during a prior garbage collection cycle, and assume that the pointer holds the address of a location in memory that was previously associated with the runtime object. For the purposes of this example, further assume that a garbage collector (e.g., a garbage collector thread or a program thread executing a barrier) encounters the pointer during the concurrent marking phase. In this example, the garbage collector finds that the pointer stores bad colors (e.g., good colors from the prior garbage collection cycle), and the garbage collector strips the bad colors from the pointer. Furthermore, the garbage collector learns that the pointer of this example requires remapping by referencing a forwarding table that holds another address of another location in memory that is currently associated with the runtime object, and the garbage collector remaps the pointer by storing the other address to the pointer. Having remapped the pointer of this example to the other address, the pointer now qualifies as load good, and the garbage collector colors the pointer accordingly. Specifically, the garbage collector stores a good color to a set of remapping bits within the pointer of this example. As long as the good colors remain unchanged, the pointer of this example retains the load good designation. Note that during the concurrent marking phase, any time that a garbage collector encounters a broken pointer, the garbage collector will repair that broken pointer. Thus, it can be expected that the garbage collector will inevitably store a good color to the remapping bits of any pointer that the garbage collector encounters. Accordingly, whenever a thread encounters a pointer that is colored load bad, the thread can conclude that the pointer has not yet been processed since the beginning of the concurrent marking phase.

The system, according to an embodiment, marks through a strong object graph of the memory area during the concurrent marking phase. While marking through the strongly reachable objects in the memory area, the system colors pointers corresponding to strong references. As an example, consider a runtime object that is strongly reachable through a strong reference corresponding to a pointer that holds the correct address of a location in memory associated with the runtime object. In this example, the pointer qualifies as load good, reachable good, and strongly reachable good. Thus, a garbage collector colors the pointer strongly reachable good. More specifically, the garbage collector (a) adds a good color to a set of remapping bits within the pointer, (b) adds a good color to a set of marking bits within the pointer, and (c) adds a good color to a set of strong marking bits within the pointer. From this point forward, the pointer of this example is colored strongly reachable good for as long as the good colors remain unchanged. Note that in this example, the good colors remain unchanged for multiple phases of the garbage collection cycle. It should also be noted that while the system is coloring pointers to strongly reachable objects, the system may also be storing state information to a live map, a discovered list, a remembered set, and/or other records of state information.

The system, according to an embodiment, marks through finalizably reachable objects residing in the memory area during the concurrent marking phase. While marking through the finalizably reachable objects, the system colors pointers to the finalizably reachable objects. As an example, consider a runtime object that is finalizably reachable through a reference (e.g., a strong reference or a non-strong reference) corresponding to a pointer that holds the correct address of the runtime object. In this example, the pointer qualifies as load good, and the pointer qualifies as reachable good. Therefore, a garbage collector (e.g., a garbage collector thread) colors the pointer reachable good. More specifically, the garbage collector adds a good color to a set of remapping bits within the pointer, and the garbage collector adds a good color to a set of marking bits within the pointer. From this point forward, the pointer is at least colored reachable good for as long as the good colors remain unchanged. Furthermore, the pointer may gain the additional state designations of strongly reachable good and/or store good. It should also be noted that while the system is coloring pointers to finalizably reachable objects, the system may also be storing state information to a live map, a discovered list, a remembered set, and/or other records of state information.

During the concurrent marking phase, the system, according to an embodiment, marks through runtime objects that are (a) reachable and (b) neither strongly reachable nor finalizably reachable. For instance, the system marks through softly reachable objects and/or weakly reachable objects while generating reached-by-data structures. While marking through runtime objects that are (a) reachable and (b) neither strongly reachable nor finalizably reachable, the system colors pointers. As an example, consider a runtime object that is softly reachable or weakly reachable through a reference (e.g., a strong reference or a non-strong reference) corresponding to a pointer that holds the correct address of the runtime object. In this example, the pointer qualifies as load good and reachable good. Therefore, a garbage collector colors the pointer reachable good. From this point forward, the pointer is at least colored reachable good for as long as the good colors remain unchanged. Furthermore, the pointer may gain the additional state designations of strongly reachable good and/or store good. It should also be noted that while the system is marking through the runtime objects that are (a) reachable and (b) neither strongly reachable nor finalizably reachable, the system may also be storing state information to reached-by-data structures, a remembered set, and/or other records of state information.

The system, according to an embodiment, generates other records of state information while coloring pointers during the concurrent marking phase. Examples of other records of state information that may be generated during the concurrent marking phase include a live map, a discovered list, a reached-by-data structure, a remembered set, a resurrected set, and others. In some cases, the system records the same information in multiple records of state information. For example, a colored pointer and a live map may both indicate that one runtime object is strongly reachable, and another colored pointer and a reached-by-data structure may both indicate that another runtime object is reachable. However, in other cases, the state of a runtime object as indicated by a colored pointer may differ from the state of the runtime object as indicated by another record of state information. The system may record a runtime object as having a particular state (that is not necessarily the runtime object's actual state) in a particular record of state information to influence how a particular aspect of the system will treat with that runtime object in subsequent interactions. For instance, the system may color pointers to influence what collection operations will be performed by program threads while executing barriers, and the system generates other records of state information (e.g., a live map and a discovered list) to influence determinations regarding what runtime objects are collected. In some circumstances, the system may desire a program thread to treat a runtime object as having one state, and the system may desire a collection determination to assume that the runtime object has another state that is not strictly consistent with the one state. For example, a live map may indicate that a runtime object is a dead object, whereas a colored pointer may indicate that the runtime object is reachable. It should also be noted that as a result of enforcing monotonic transitions to pointers, the reachability status of a runtime object as recorded by a pointer can only be upgraded during a concurrent phase assuming that the pointer is not remapped to another runtime object. As a result, a colored pointer does not necessarily reflect the current state of a runtime object. For example, a colored pointer may dictate that a runtime object is treated as strongly reachable for the entirety of a concurrent phase even if that runtime object was strongly reachable for a brief portion of the concurrent phase. As is discussed above, enforcing monotonic state transitions to colored pointers is advantageous for ensuring that concurrent operations are executed harmoniously and efficiently. However, it should also be noted that while the system is enforcing strictly monotonic state transitions on pointers, the system can simultaneously account for non-monotonic changes to a runtime object's state using other records of state information.

In an embodiment, the system imposes barriers on program threads to prevent concurrency issues while the system is performing a concurrent reference processing phase (Operation 1006). The logic defined by these barriers relies on the coloring of pointers as an input. Recall that during a concurrent reference processing phase, the system processes reference objects that are included in a discovered list. Note that the addition of a reference object to a discovered list does not prevent a program instance from accessing the reference object. Therefore, if left unchecked, a program thread could cause a concurrency issue by dereferencing a reference object that is included in the discovered list. For instance, if a program thread is allowed to dereference a reference object (e.g., a soft reference object or a weak reference object) included in the discovered list before the system is able to clear that reference object, runtime objects that are reachable through that reference object may be resurrected. Note that in this example, the system has previously decided that those resurrected objects are disposable. Consequently, program errors, memory loss, dangling pointers, crashed processes, and/or other problems could occur in this example. To prevent these issues, the system imposes barriers on program threads attempting program operations that involve calling the get( ) method of a reference object during the concurrent reference processing phase. As an example, assume that a program thread, while performing a program operation, attempts to dereference a dereferenceable reference object residing in the memory area during the concurrent reference processing phase by calling a get( ) method of the reference object. Prior to the program thread being permitted to call the get( ) method, a barrier is imposed on the program thread. While executing the barrier, the program thread infers whether or not the reference object will have potentially been included in a discovered list based on the coloring of the pointer corresponding to the non-strong reference that is held by the reference object. Recall that (a) a reference object is potentially eligible for inclusion in a discovered list as long as the reference object's referent is not strongly reachable and (b) a pointer being colored reachable good indicates that the runtime object is reachable but not strongly reachable. Therefore, if the corresponding pointer is colored reachable good in this example, the barrier will block the program thread from dereferencing the reference object (e.g., by simulating the get( ) method returning null instead of returning the referent). Alternatively, if the corresponding pointer is colored strongly reachable good in this example, the barrier may permit the program operation to proceed without further interference.

In an embodiment, the system performs a selection phase of the garbage collection cycle (Operation 1008). Recall that during a selection phase, the system selects candidate regions for inclusion in an evacuation candidate set.

In an embodiment, the system resets the state machine prior to commencing the relocating of runtime objects during a concurrent relocation phase of the garbage collection cycle (Operation 1010). The system resets the state machine by determining new good colors for coloring pointers and storing the new good colors to one or more locations where the new good colors can be readily accessed by a program thread and/or a garbage collector thread. Note that determining a new good color for coloring a set of bits within a pointer renders the previous good color for that set of bits bad. As a result, the colored pointers lose state designation that were assigned to the colored pointers during the concurrent marking phase. The system resets the state machine while a program instance is paused, and/or the system resets the state machine while a program instance is running. In an example, the system determines the new good colors during a stop the world phase that immediately precedes the commencement of concurrent relocation operations. In this example, the system (a) encodes the new good colors into barriers (e.g., load barriers and store barriers), (b) stores the new good colors to global variables, (c) stores the new good colors into thread-local variables, and/or (d) stores the new good colors to other locations. During the stop the world phase of this example, the system may also perform other collection operations prior to beginning concurrent relocation operations. For instance, during the stop the world phase, the system may relocate the root objects that reside in the candidate regions listed in an evacuation candidate set.

The system, according to an embodiment, resets the state machine for the garbage collection cycle, and/or the system resets the state machine for other garbage collection cycle(s). Recall that the system may be performing multiple garbage collection cycles in the memory area at the same time.

Prior to commencing the concurrent relocation phase, the system, according to an embodiment, resets the state machine by determining new good color for coloring the remapping bits of pointers. Note that determining a new good color for the remapping bits of pointers will result in pointers losing any state designations that were previously assigned to those pointers during the concurrent marking phase or another phase of the garbage collection cycle.

In an embodiment, the system colors pointers while relocating runtime objects residing in the memory area during a concurrent relocation phase (Operation 1012). More specifically, the system colors pointers while relocating runtime objects residing in candidate regions of the memory area. As an example, consider a pointer that refers to a runtime object, and assume that the runtime object resides in a candidate region. For the purpose of this example, further assume that the runtime object was marked as strongly reachable during the marking phase of the garbage collection cycle. In this example, a garbage collector relocates the runtime object to another region of the memory area based on a forwarding table. Having relocated the runtime object, the garbage collector may remap the pointer to the new address associated with the runtime object, and the garbage collector may store a good color to a set of remapping bits within the pointer to color the pointer load good. In this example, if a thread subsequently encounters the pointer during the concurrent relocation phase, the thread can conclude, based on the pointer's color, that the pointer does not refer to a runtime object currently residing in a candidate region. Note that some pointers may remain broken after the concurrent relocation phase ends. Any broken pointers may be lazily corrected in subsequent phases and/or subsequent garbage collection cycles.

During the concurrent relocation phase, the system, according to an embodiment, imposes barriers on program threads attempting program operations in the memory area. Pursuant to a barrier, a program thread may be compelled to relocate a runtime object residing in a candidate region, remap a pointer, color a pointer, and/or perform other relocation operations. As an example, assume that a program thread attempts a program operation involving a pointer to a runtime object residing in a candidate region of the memory area during the concurrent relocation phase. In this example, the program thread, acting pursuant to a barrier, is made to check the coloring of the pointer to determine if the runtime object potentially is currently residing in a candidate region. If the pointer is colored load good, the program thread can conclude that the runtime object does not need to be relocated, and the program thread is permitted to proceed with the program operation. Alternatively, if the pointer holds bad colors or no colors, the program thread, acting pursuant to the barrier, checks if the runtime object is an object that requires relocating during the concurrent relocation phase (e.g., by consulting a forwarding table). If the runtime object does not reside in a candidate region, the program thread may color the pointer load good and proceed with the program operation. Alternatively, if the runtime object needs to be relocated, the barrier compels the program thread to relocate the runtime object, remap the pointer, and/or color the pointer load good prior to performing the program operation.

### 8. Example Embodiment

Detailed examples are described below for purposes of clarity. Components and/or operations described below should be understood as specific examples that may not be applicable to certain embodiments. Accordingly, components and/or operations described below should not be construed as limiting the scope of any of the claims.

### 8.1 Example Load Barrier

FIG. 11 illustrates an example marking operations that may be performed by a program thread pursuant to a load barrier in accordance with an example embodiment. The load barrier is an additional set of machine-level instructions that are injected into the machine-level code of a program instance that is being executed by the program thread. The load barrier is injected into the machine-level code of the program instance proximate to instructions for reading a reference (i.e., a load operation) that is carried in an object field of a runtime object residing in a memory area. The reference is implemented in memory, at least in part, using a pointer that holds an address associated with another runtime object residing in the memory area (referred to as “the target object”). The load barrier is imposed on the program thread as a consequence of the program instance requesting the load operation while a concurrent marking phase is ongoing in the memory area. One or more operations illustrated in FIG. 11 may be modified, rearranged, or omitted all together. Accordingly the particular sequence of operations illustrated in FIG. 11 should not be construed as limiting on the scope of one or more embodiments.

In an example embodiment, the program thread, acting pursuant to the load barrier, determines if the pointer is colored load bad, and the program thread proceeds to another operation based on the determination (Operation 1102). To this end, the program thread compares the coloring of the pointer to the current good colors for the garbage collection cycle. The current good colors are encoded within the load barrier. As a result, the program thread avoids the computational cost that would be associated with the program thread having to look elsewhere to learn the current good colors. If the pointer is colored strongly reachable bad (YES in Operation 1102), the program thread proceeds to Operation 1104. In this scenario, the program thread follows a slow path of the load barrier. The slow path requires the program thread to perform additional collection operation(s) before and/or after the load operation. Note that the load barrier includes several slow paths for differing circumstances. Alternatively, if the pointer does not contain any bad colors (NO in Operation 1102), the program thread proceeds to Operation 1110.

In an example embodiment, the program thread, acting pursuant to the load barrier, strips any bad colors stored to the pointer (Operation 1104). For instance, the program thread removes any bad colors within the pointer that are stored to remapping bits, marking bits, strong marking bits, and/or remembered bits.

In an example embodiment, the program thread, acting pursuant to the load barrier, determines if the pointer needs to be remapped, and the program thread proceeds to another operation based on the determination (Operation 1106). To determine if the pointer needs to be remapped, the program thread may consult a forwarding table and/or other data structures. If the pointer needs to be remapped (YES in Operation 1106), the program thread proceeds to Operation 1108. Alternatively, if the pointer does not need to be remapped (NO in Operation 1106), the program thread proceeds to Operation 1110.

In an example embodiment, the program thread, acting pursuant to the load barrier, remaps the pointer (Operation 1108). More specifically, the program thread accesses the correct address of the target object, and the program thread stores the correct address of the target object to a set of address bits within the pointer. The program thread retrieves the correct address of the target object from a forwarding table or another data structure.

In an example embodiment, the program thread, acting pursuant to the load barrier, determines if the load operation potentially resurrects the target object, and the program thread proceeds to another operation based on the determination (Operation 1110). The load operation potentially resurrects the target object if (a) the runtime object holding the reference is a dereferenceable reference object (e.g., a soft reference object or a weak reference object), (b) the object field that carries the reference is the reference object's referent field, and (c) the pointer is colored strongly reachable bad (i.e., the coloring of the pointer indicates that the target object is not strongly reachable). If the load operation potentially resurrects the target object (YES in Operation 1110), the program thread proceeds to Operation 1112. In this scenario, the program thread follows a slow path of the load barrier. Alternatively, if the load operation does not resurrect the target object (NO in Operation 1110), the program thread proceeds to Operation 1116. In this alternative scenario, the program thread follows a fast path of the load barrier. The fast path requires the program thread to perform few or no additional collection operations before and/or after the load operation.

In an example embodiment, the program thread, acting pursuant to the load barrier, informs a garbage collector thread of the resurrection (Operation 1112). Informing the garbage collector thread of the resurrection alerts the garbage collector thread to the fact that (a) the load operation changes the target object's reachability status and (b) the load operation may change the reachability status of other runtime objects residing in the memory area (e.g., runtime objects reachable through the target object). If a garbage collector thread is currently marking through runtime objects, the program thread may alert the garbage collector thread to the resurrection by adding an entry to the garbage collector thread's marking stack. Adding the entry to the garbage collector thread's marking stack ensures that the garbage collector thread will mark through the target object while treating the target object as strongly reachable. Furthermore, the garbage collector thread will mark through any other runtime objects that have become strongly reachable as a result of the resurrection. Note that the manner that the program thread alerts a garbage collector thread to the resurrection may vary depending on the circumstances. For instance, if the load operation occurs while an attempt to terminate the concurrent marking phase is ongoing, the program thread foregoes adding an entry to garbage collector thread's marking stack. Instead, the program thread generates an entry in a resurrected set. Based on the resurrected set and/or a reached-by-data structure, a garbage collector will update records of state information to reflect the resurrection after the concurrent marking phase has been terminated.

In an example embodiment, the program thread, acting pursuant to the load barrier, colors the pointer to reflect the resurrection of the target object (Operation 1114). More specifically, the program thread colors the pointer strongly reachable good. Note that the precise operations that are required for coloring the pointer strongly reachable good may vary depending on whether or not the pointer has been processed by a garbage collector since the good colors were last updated. Alternatively, the program thread foregoes coloring the pointer strongly reachable good, and leaves all pointer coloring operations to be performed by the garbage collector thread.

In an example embodiment, the program thread, having completed any collection operations required by the load barrier, performs the load operation requested by the program instance (Operation 1116).

### 8.2 Example Store Barrier

FIG. 12 illustrates example marking operations that may be performed by a program thread pursuant to a store barrier in accordance with an example embodiment. The store barrier is an additional set of machine-level instructions that are injected into the machine-level code of a program instance that is being executed by the program thread proximate to instructions in the machine-level code of the program instance for a new reference to be stored in an object field (i.e., a store operation) of a runtime object residing in a memory area. Note that performing the store operation will remap a pointer from one runtime object (referred to as “the initial target object”) to another runtime object (referred to as “the new target object”). The store barrier is imposed on the program thread as a consequence of the program instance requesting the store operation while a concurrent marking phase of a garbage collection cycle is ongoing in the memory area. One or more operations illustrated in FIG. 12 may be modified, rearranged, or omitted all together. Accordingly the particular sequence of operations illustrated in FIG. 12 should not be construed as limiting on the scope of one or more embodiments.

In an example embodiment, the program thread, acting pursuant to the store barrier, determines if the store operation is the first store to the object field of the runtime object since a monotonic state machine was last reset (referred to in short as “the first store”), and the program thread proceeds to another operation based on the determination (Operation 1202). In other words, the program thread determines if the store operation is the first store since the good colors for the garbage collection cycle were last updated. The program thread determines if the store operation is the first store by comparing the current good colors to the coloring of the pointer. The current good colors are encoded within the store barrier. As a result, the program thread avoids the computational cost that would be associated with the program thread having to look elsewhere to learn the current good colors. The store operation is the first store if the pointer is colored load bad, reachable bad, strongly reachable bad, or store bad. As is discussed below, a store barrier will require a program thread to color any given pointer store good when performing the first store on a corresponding object field since the good colors were last updated. Therefore, if the pointer is colored store good, the program thread can infer that the store operation is not the first store. If the store operation is the first store (YES at Operation 1202), the program thread proceeds to Operation 1204. In this scenario, the program thread follows a slow path of the store barrier. The slow path requires the program thread to perform additional collection operation(s) before and/or after the store operation. Note that the store barrier may include several slow paths for differing circumstances. Alternatively, if the store operation is not the first store (NO at Operation 1202), the program thread proceeds directly to Operation 1214. In this alternative scenario, the program thread follows a fast path of the store barrier. The fast path requires the program thread to perform few or no additional collection operations before and/or after the store operation.

In an example embodiment, the program thread, acting pursuant to the store barrier, determines if a store barrier buffer is full, and the program thread proceeds to another operation based on the determination (Operation 1204). If the store barrier buffer is full (YES at Operation 1204), the program thread proceeds onward to Operation 1206. Alternatively, if the store barrier buffer is not full, (NO at Operation 1204), the system proceeds to Operation 1214.

In an example embodiment, the program thread, acting pursuant to the store barrier, adds the object field to a remembered set (Operation 1206). More specifically, the particular field may be added to the remembered set if (a) the memory area includes multiple generations and (b) the reference that is being stored to the object field potentially crosses from one generation into another generation. If the memory area does not include multiple generations, the program thread may skip Operation 1206 and proceed directly to Operation 1208.

In an example embodiment, the program thread, acting pursuant to the store barrier, notifies a garbage collector thread of the store operation (Operation 1208). Informing the garbage collector thread of the store operation alerts the garbage collector thread to any potential change to the reachability of runtime objects residing in the memory area that may result from the store operation. If the garbage collector thread is currently marking through runtime objects in the memory area, the program thread notifies the garbage collector thread of the store operation by adding an entry to the garbage collector thread's marking stack. An example entry in the marking stack that is created by the program thread identifies (a) the object field, (b) the initial target object, and/or (c) other information. Adding the entry to the marking stack may ensure that the garbage collector thread marks through the initial target object even if the store operation renders the initial target object unreachable. A garbage collector typically does not mark through an unreachable object during a concurrent marking phase; however, if the concurrent marking phase is a SATB marking phase, the garbage collector may need to mark through an unreachable object if that unreachable object was formerly reachable (e.g., strongly reachable) at the beginning of the SATB marking phase (i.e., when the snapshot was generated). Note that a garbage collector only needs to be made aware of the first store to the object field. The garbage collector does not need to be made aware of any subsequent store to the object field during a SATB marking phase because the garbage collector is guaranteed to uncover these additional changes while marking through the runtime objects. It should also be noted that the manner the program thread alerts the garbage collector thread to the store operation may vary. For instance, if (a) the program instance is requesting the store operation to be performed while a termination procedure for the concurrent marking phase is ongoing and (b) the store operation will cause a resurrection, the program thread foregoes adding an entry to garbage collector thread's marking stack. Instead, the program thread generates an entry in a resurrected set. Based on the resurrected set and/or a reached-by-data structure, a garbage collector will update records of state information to reflect the resurrection after the concurrent marking phase has been terminated. Note that the store operation may cause a resurrection if the program thread creates a strong reference to a runtime object that was not previously strongly reachable while the program thread is in the process of performing the store operation (e.g., by dereferencing a soft reference object or a weak reference object).

In an example embodiment, the program thread, acting pursuant to the store barrier, colors the pointer store good (Operation 1210). Note that the precise operations that are required for coloring the pointer store good may vary depending on whether or not the pointer has been processed by a garbage collector since the good colors were last updated.

In an example embodiment, the program thread, acting pursuant to the store barrier, generates an entry in a store barrier buffer (Operation 1212). An example entry in the store barrier buffer identifies (a) the object field, (b) the initial target object, and/or (c) other information. Generating the entry in the store barrier buffer (a) alerts a garbage collector thread to the store operation thereby ensuring that the garbage collector thread marks through the initial target object and (b) delegates the performance of the collection operations defined by the slow path of the store barrier (e.g., Operation 1206, Operation 1208, and Operation 1210) to the garbage collector thread. Note that using the store barrier buffer to delegate collection operations to garbage collector threads may further reduce the impact on the performance of the program instance that is exacted by imposing the store barrier on the program thread.

In an example embodiment, the program thread performs the store operation on the object field (Operation 1214). While performing the store operation, the program thread stores a new address to a set of address bits within the pointer. As a result, the pointer is remapped from the initial target object to the new target object.

### 8.3 Example Pointer Coloring

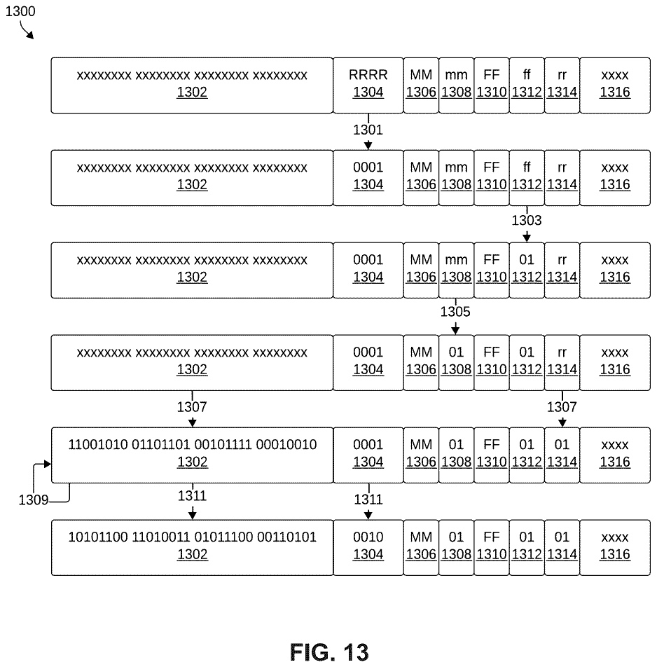

FIG. 13 illustrates example collection operations for coloring a pointer 1300 in accordance with an example embodiment. In the example illustrated by FIG. 13, pointer 1300 initially refers to one runtime object (referred to as “the initial target object”), and pointer 1300 subsequently refers to another runtime object (referred to as “the new target object”). The initial target object and the new target object reside in a memory area that is being subjected to a garbage collection process. The memory area includes a young generation and an old generation. Note that (a) either generation may be subjected to a concurrent garbage collection cycle and (b) the system may perform one concurrent garbage collection cycle in the young generation while the system is also performing another concurrent garbage collection cycle in the old generation. A reference corresponding to pointer 1300 is carried in an object field of yet another runtime object residing within the memory area. As illustrated in FIG. 13, pointer 1300 includes address bits 1302, remapping bits (RRRR) 1304, old strong marking bits (MM) 1306, young strong marking bits (mm) 1308, old marking bits (FF) 1310, young marking bits (ff) 1312, remembered bits (rr) 1314, and extra bits 1316. For the purposes of the example depicted by FIG. 13, assume that each of (a) remapping bits 1304, (b) old strong marking bits 1306, (c) young strong marking bits 1308, (d) old marking bits 1310, (e) young marking bits 1312, and (f) remembered bits 1314 contains a bad color or no color in the moment immediately preceding Operation 1301. In one or more embodiments, a pointer 1300 may include more or fewer components than the components illustrated in FIG. 13, and/or one or more components of pointer 1300 as illustrated in FIG. 13 may be modified, rearranged, or omitted all together. Furthermore, one or more operations illustrated in FIG. 13 may be modified, rearranged, or omitted all together. Accordingly the particular sequence of operations illustrated in FIG. 13 should not be construed as limiting on the scope of one or more embodiments.

In an example embodiment, a garbage collector stores a good color to remapping bits 1304 during a concurrent marking phase targeting the young generation of the memory area (Operation 1301). In other words, the garbage collector color pointer 1300 as load good. The garbage collector colors pointer 1300 load good in response to determining that address bits 1302 contain the correct address of the initial target object. Pointer 1300 is colored load good by a garbage collector thread, or pointer 1300 is colored load good by a program thread executing a barrier.

In an example embodiment, a garbage collector stores a good color to young marking bits 1312 during a concurrent marking phase targeting the young generation of the memory area (Operation 1303). In other words, the garbage collector colors the pointer 1300 reachable good in the young generation of the memory area. The garbage collector stores the good color to young marking bits 1312 in response to determining that the initial target object should be treated as reachable from the young generation. Pointer 1300 is colored reachable good in the young generation by a garbage collector thread, or pointer 1300 is colored reachable good in the young generation by a program thread executing a barrier.

In an example embodiment, a garbage collector stores a good color to young strong marking bits 1308 during a concurrent marking phase targeting the young generation of the memory area (Operation 1305). In other words, the garbage collector colors pointer 1300 strongly reachable good in the young generation. The garbage collector stores the good color to young strong marking bits 1308 in response to determining that the initial target object should be treated as strongly reachable from the young generation of the memory area. Pointer 1300 is colored strongly reachable good by a garbage collector thread, or pointer 1300 is colored strongly reachable good by a program thread executing a barrier.

In an example embodiment, a program thread stores a current address of a new target object to address bits 1302 while performing a store operation requested by a program instance during a concurrent marking phase targeting the young generation of the memory area, and the program thread stores a good color to remembered bits 1314 while executing a store barrier corresponding to the store operation (Operation 1307). In other words, the program thread remaps pointer 1300, and the program thread colors pointer 1300 store good. Note that, even if the new target object is not strongly reachable good through the reference corresponding to pointer 1300, pointer 1300 may nonetheless qualify as strongly reachable good during the store operation because the program thread will typically create a temporary strong reference to the new target object prior to storing the new address of the new target object to address bits 1302.

In an example embodiment, a garbage collector pauses the program threads, and the garbage collector resets a monotonic state machine tracking the concurrent garbage collection cycle targeting the young generation of the memory area (Operation 1309). In particular, the system determines a new good color for remapping bits 1304. As a result of determining the new good color for remapping bits 1304, pointer 1300 is colored load bad. Consequently, pointer 1300 is neither load good, reachable good, strongly reachable, nor store good.

In an example embodiment, during a concurrent relocation phase targeting the young generation of the memory area, a garbage collector (a) relocates the new target object from a candidate region to a non-candidate region, (b) stores a new current address of the target object to address bits 1302, and (c) stores a new good color to remapping bits 1304 (Operation 1311). Therefore, pointer 1300 is now once again colored load good. The relocating of the target object is performed by a garbage collector thread, or the relocating of the target object is performed by a program thread executing a barrier. Furthermore, the remapping and recoloring of the pointer 1300 is performed by a garbage collector thread, or the remapping and recoloring of the pointer 1300 is performed by a program thread executing a barrier. Additionally, the garbage collector may strip any bad colors stored to other bits within pointer 1300.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

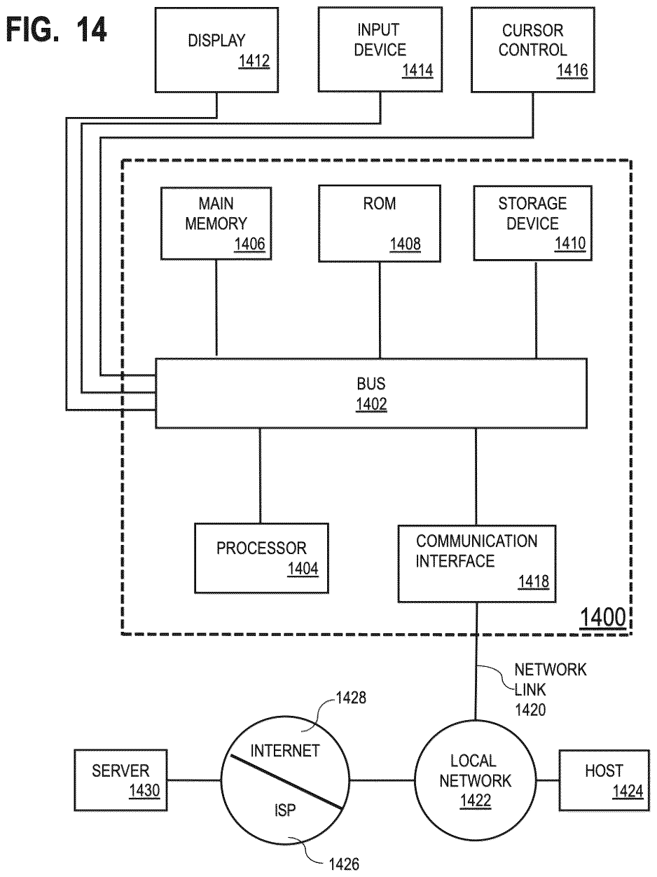

For example, FIG. 14 is a block diagram that illustrates a computer system 1400 upon which an embodiment of the disclosure may be implemented. Computer system 1400 includes a bus 1402 or other communication mechanism for communicating information, and a hardware processor 1404 coupled with bus 1402 for processing information. Hardware processor 1404 may be, for example, a general purpose microprocessor.

Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, such as a magnetic disk or optical disk, is provided and coupled to bus 1402 for storing information and instructions.

Computer system 1400 may be coupled via bus 1402 to a display 1412, such as a cathode ray tube (CRT), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane.

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1410. Volatile media includes dynamic memory, such as main memory 1406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world wide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

### 10. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
determining a first value to indicate a given runtime object is reachable, wherein the given runtime object is reachable if the given runtime object is at least one of: (a) linked to a first root object by a first chain of one or more references originating from the first root object or (b) linked to a first reference object of a particular type of reference object through a second chain of one or more references originating from the first reference object;
executing a concurrent marking phase of a garbage collection process, wherein at least one garbage collector thread is marking through runtime objects in a set of runtime objects that are concurrently being manipulated by at least one program thread that is executing a program instance; and
responsive to determining, by the at least one garbage collector thread or the at least one program thread, that a first runtime object is reachable, storing the first value in a first set of one or more bits comprised within a first pointer to the first runtime object.

2. The one or more non-transitory computer-readable media of claim 1, wherein the operations further comprise:
determining a second value to indicate the given runtime object is strongly reachable, wherein the given runtime object is strongly reachable if the given runtime object is at least one of:
(a) accessible through the first chain of one or more references, wherein the first chain of one or more references does not include a reference of a second reference type that is comprised within a reference object or
(b) accessible through a third chain of one or more references of a first reference type, wherein the third chain of one or more references originates from the first root object or a second root object; and
responsive to determining, by the at least one garbage collector thread or the at least one program thread, that the first runtime object is strongly reachable, storing the second value to a second set of one or more bits comprised within the first pointer to the first runtime object, wherein (a) the first value is not removed from the first set of one or more bits during the concurrent marking phase and (b) the second value is not removed from the second set of one or more bits during the concurrent marking phase.

3. The one or more non-transitory computer-readable media of claim 2, wherein the particular type of reference object is a final type of reference object, wherein the first reference type is a strong reference type, wherein the second reference type is a non-strong reference type, and wherein the first runtime object being strongly reachable necessarily implies that the first runtime object is also reachable.

4. The one or more non-transitory computer-readable media of claim 2, wherein the operations further comprise:
determining a third value to indicate that a given pointer to the given runtime object does not need remapping, wherein the given pointer to the given runtime object does not need remapping if the given pointer stores at least one of: (a) a first address corresponding to a current location of the given runtime object or (b) a second address corresponding to a future location of the given runtime object; and
responsive to determining, by the at least one garbage collector thread or the at least one program thread, that the first pointer to the first runtime object does not need remapping, storing the third value to a third set of one or more bits comprised within the first pointer to the first runtime object, wherein the third value is not removed from the third set of one or more during the concurrent marking phase.

5. The one or more non-transitory computer-readable media of claim 4, wherein the operations further comprise:
determining a fourth value to indicate that (a) the given pointer is included in a set of one or more references that potentially cross a generational boundary of a memory area comprising the set of runtime objects and/or (b) the at least one program thread has remapped the given pointer while executing the program instance, wherein the at least one program thread remaps the given pointer while executing the program instance if the program thread stores a new address to the given pointer while executing the program instance;
subsequent to determining the fourth value:
responsive to determining, by the at least one program thread, that the fourth value is not stored to a fourth set of one or more bits comprised within the first pointer to the first runtime object, storing the fourth value to the fourth set of one or more bits comprised within the first pointer, wherein the fourth value is not removed from the fourth set of one or more bits during the concurrent marking phase; and
storing, by the at least one program thread while executing the program instance, the new address to a set of address bits comprised within the first pointer.

6. The one or more non-transitory computer-readable media of claim 5, wherein the fourth value is not stored to the fourth set of one or more bits unless the second value is also stored to the second set of one or more bits, wherein the second value is not stored to the second set of one or more bits unless the first value is also stored to the first set of one or more bits, and wherein the first value is not stored to the first set of one or more bits unless the third value is also stored to the third set of one or more bits.

7. The one or more non-transitory computer-readable media of claim 4, wherein the operations further comprise:
responsive to determining, by the at least one garbage collector thread during the concurrent marking phase, that a second pointer to a second runtime object does not need remapping, storing the third value to a seventh set of one or more bits comprised within the second pointer, wherein the third value is not removed from the seventh set of one or more bits during the concurrent marking phase; and
responsive to determining, by the at least one garbage collector thread during the concurrent marking phase, that the second runtime object is linked to a second reference object of the particular type of reference object by a fourth chain of one or more references, storing the first value to a fifth set of one or more bits comprised within the second pointer to the second runtime object, wherein the first value is not removed from the fifth set of one or more bits during the concurrent marking phase.

8. A method comprising:
determining a first value to indicate a given runtime object is reachable, wherein the given runtime object is reachable if the given runtime object is at least one of: (a) linked to a first root object by a first chain of one or more references originating from the first root object or (b) linked to a first reference object of a particular type of reference object through a second chain of one or more references originating from the first reference object;
executing a concurrent marking phase of a garbage collection process, wherein at least one garbage collector thread is marking through runtime objects in a set of runtime objects that are concurrently being manipulated by at least one program thread that is executing a program instance; and
responsive to determining, by the at least one garbage collector thread or the at least one program thread, that a first runtime object is reachable, storing the first value in a first set of one or more bits comprised within a first pointer to the first runtime object,
wherein the method is performed by at least one device including a hardware processor.

9. The method of claim 8, further comprising:
determining a second value to indicate the given runtime object is strongly reachable, wherein the given runtime object is strongly reachable if the given runtime object is at least one of:
(a) accessible through the first chain of one or more references, wherein the first chain of one or more references does not include a reference of a second reference type that is comprised within a reference object or
(b) accessible through a third chain of one or more references of a first reference type, wherein the third chain of one or more references originates from the first root object or a second root object; and
responsive to determining, by the at least one garbage collector thread or the at least one program thread, that the first runtime object is strongly reachable, storing the second value to a second set of one or more bits comprised within the first pointer to the first runtime object, wherein (a) the first value is not removed from the first set of one or more bits during the concurrent marking phase and (b) the second value is not removed from the second set of one or more bits during the concurrent marking phase.

10. The method of claim 9, wherein the particular type of reference object is a final type of reference object, wherein the first reference type is a strong reference type, wherein the second reference type is a non-strong reference type, and wherein the first runtime object being strongly reachable necessarily implies that the first runtime object is also reachable.

11. The method of claim 9, further comprising:
determining a third value to indicate that a given pointer to the given runtime object does not need remapping, wherein the given pointer to the given runtime object does not need remapping if the given pointer stores at least one of: (a) a first address corresponding to a current location of the given runtime object or (b) a second address corresponding to a future location of the given runtime object; and
responsive to determining, by the at least one garbage collector thread or the at least one program thread, that the first pointer to the first runtime object does not need remapping, storing the third value to a third set of one or more bits comprised within the first pointer to the first runtime object, wherein the third value is not removed from the third set of one or more during the concurrent marking phase.

12. The method of claim 11, further comprising:
determining a fourth value to indicate that (a) the given pointer is included in a set of one or more references that potentially cross a generational boundary of a memory area comprising the set of runtime objects and/or (b) the at least one program thread has remapped the given pointer while executing the program instance, wherein the at least one program thread remaps the given pointer while executing the program instance if the program thread stores a new address to the given pointer while executing the program instance;
subsequent to determining the fourth value:
responsive to determining, by the at least one program thread, that the fourth value is not stored to a fourth set of one or more bits comprised within the first pointer to the first runtime object, storing the fourth value to the fourth set of one or more bits comprised within the first pointer, wherein the fourth value is not removed from the fourth set of one or more bits during the concurrent marking phase; and
storing, by the at least one program thread while executing the program instance, the new address to a set of address bits comprised within the first pointer.

13. The method of claim 12, wherein the fourth value is not stored to the fourth set of one or more bits unless the second value is also stored to the second set of one or more bits, wherein the second value is not stored to the second set of one or more bits unless the first value is also stored to the first set of one or more bits, and wherein the first value is not stored to the first set of one or more bits unless the third value is also stored to the third set of one or more bits.

14. The method of claim 11, further comprising:
responsive to determining, by the at least one garbage collector thread during the concurrent marking phase, that a second pointer to a second runtime object does not need remapping, storing the third value to a seventh set of one or more bits comprised within the second pointer, wherein the third value is not removed from the seventh set of one or more bits during the concurrent marking phase; and
responsive to determining, by the at least one garbage collector thread during the concurrent marking phase, that the second runtime object is linked to a second reference object of the particular type of reference object by a fourth chain of one or more references, storing the first value to a fifth set of one or more bits comprised within the second pointer to the second runtime object, wherein the first value is not removed from the fifth set of one or more bits during the concurrent marking phase.

15. A system comprising:
at least one device including a hardware processor;
the system being configured to perform operations comprising:
determining a first value to indicate a given runtime object is reachable, wherein the given runtime object is reachable if the given runtime object is at least one of: (a) linked to a first root object by a first chain of one or more references originating from the first root object or (b) linked to a first reference object of a particular type of reference object through a second chain of one or more references originating from the first reference object;
executing a concurrent marking phase of a garbage collection process, wherein at least one garbage collector thread is marking through runtime objects in a set of runtime objects that are concurrently being manipulated by at least one program thread that is executing a program instance; and
responsive to determining, by the at least one garbage collector thread or the at least one program thread, that a first runtime object is reachable, storing the first value in a first set of one or more bits comprised within a first pointer to the first runtime object.

16. The system of claim 15, wherein the operations further comprise:
determining a second value to indicate the given runtime object is strongly reachable, wherein the given runtime object is strongly reachable if the given runtime object is at least one of:
(a) accessible through the first chain of one or more references, wherein the first chain of one or more references does not include a reference of a second reference type that is comprised within a reference object or
(b) accessible through a third chain of one or more references of a first reference type, wherein the third chain of one or more references originates from the first root object or a second root object; and
responsive to determining, by the at least one garbage collector thread or the at least one program thread, that the first runtime object is strongly reachable, storing the second value to a second set of one or more bits comprised within the first pointer
to the first runtime object, wherein (a) the first value is not removed from the first set of one or more bits during the concurrent marking phase and (b) the second value is not removed from the second set of one or more bits during the concurrent marking phase.

17. The system of claim 16, wherein the particular type of reference object is a final type of reference object, wherein the first reference type is a strong reference type, wherein the second reference type is a non-strong reference type, and wherein the first runtime object being strongly reachable necessarily implies that the first runtime object is also reachable.

18. The system of claim 16, wherein the operations further comprise:
determining a third value to indicate that a given pointer to the given runtime object does not need remapping, wherein the given pointer to the given runtime object does not need remapping if the given pointer stores at least one of: (a) a first address corresponding to a current location of the given runtime object or (b) a second address corresponding to a future location of the given runtime object; and
responsive to determining, by the at least one garbage collector thread or the at least one program thread, that the first pointer to the first runtime object does not need remapping, storing the third value to a third set of one or more bits comprised within the first pointer to the first runtime object, wherein the third value is not removed from the third set of one or more during the concurrent marking phase.

19. The system of claim 18, wherein the operations further comprise:
determining a fourth value to indicate that (a) the given pointer is included in a set of one or more references that potentially cross a generational boundary of a memory area comprising the set of runtime objects and/or (b) the at least one program thread has remapped the given pointer while executing the program instance, wherein the at least one program thread remaps the given pointer while executing the program instance if the program thread stores a new address to the given pointer while executing the program instance;
subsequent to determining the fourth value:
responsive to determining, by the at least one program thread, that the fourth value is not stored to a fourth set of one or more bits comprised within the first pointer to the first runtime object, storing the fourth value to the fourth set of one or more bits comprised within the first pointer, wherein the fourth value is not removed from the fourth set of one or more bits during the concurrent marking phase; and
storing, by the at least one program thread while executing the program instance, the new address to a set of address bits comprised within the first pointer.

20. The system of claim 19, wherein the fourth value is not stored to the fourth set of one or more bits unless the second value is also stored to the second set of one or more bits, wherein the second value is not stored to the second set of one or more bits unless the first value is also stored to the first set of one or more bits, and wherein the first value is not stored to the first set of one or more bits unless the third value is also stored to the third set of one or more bits.
